(19) United States
(12) Patent Application Publication
(10) Pub. No.: US 2004/0141887 A1
(43) Pub. Date: Jul. 22, 2004

(54) Apparatus and methods to process substrate surface features

(75) Inventors: James Kevin Mainquist, San Diego, CA (US); Bernhard H. Geierstanger, Del Mar, CA (US); David C. Tully, San Diego, CA (US)

Correspondence Address: QUINE INTELLECTUAL PROPERTY LAW GROUP, P.C., P O BOX 458, ALAMEDA, CA, 94501, US

(73) Assignee: IRM, LLC, Hamilton HM LX (BM)

(21) Appl. No.: 10/704,204

(22) Filed: Nov. 7, 2003

Related U.S. Application Data
(60) Provisional application No. 60/424,897, filed on Nov. 8, 2002.

(51) Int. Cl. B01L 3/00

(52) U.S. Cl. 422/102; 422/101

(57) ABSTRACT

The present invention provides apparatus for fluidly separating substrate surface features. The apparatus include arrays of apertures that correspond to at least a portion of an array of wells disposed in a micro-well plate and/or are structured to fluidly separate multiple surface features disposed on multiple substrates from one another. Related systems, kits, and methods are additionally provided.

### CROSS-REFERENCES TO RELATED APPLICATIONS

This application claims the benefit of U.S. Provisional Application No. 60/424,897, filed Nov. 8, 2002, which is incorporated by reference in its entirety for all purposes.

### COPYRIGHT NOTIFICATION

Pursuant to 37 C.F.R. § 1.71(e), Applicants note that a portion of this disclosure contains material which is subject to copyright protection. The copyright owner has no objection to the facsimile reproduction by anyone of the patent document or patent disclosure, as it appears in the Patent and Trademark Office patent file or records, but otherwise reserves all copyright rights whatsoever.

### BACKGROUND OF THE INVENTION

A microarray is generally immobilized at a predetermined surface feature of a substrate and typically includes an array of, e.g., spots that each includes probe materials (e.g., nucleic acid molecules, or other biological or chemical samples). Microarray-based assays typically include exposing the arrayed probes to fluidic samples that contain target materials, which may interact with specific probes in the microarray. In a nucleic acid microarray, for example, arrayed single-stranded synthetic oligonucleotide or cDNA probes are contacted with labeled (e.g., fluorescently, radioactively, etc.) single-stranded target nucleic acids, which hybridize with complementary probe molecules in the microarray. Since the probes are arrayed at predetermined positions, the presence and quantity of target sequences in the fluid can be identified by the position at which fluorescence or radiation is detected and the intensity of the emitted fluorescence or radiation, respectively.

Microarray technology provides the ability to perform massively parallel biological or chemical assays. The technology finds wide-ranging applicability in both basic and applied research. In basic research, for example, microarray-based assays are used in gene finding (e.g., by hybridizing cDNA to predicted open reading frames), in the identification of common regulatory elements (e.g., by gene co-expression), in evaluating pathogen/host interactions, in the analysis of mitotic and meiotic cell cycles, and in the study of evolution (e.g., by transcript profiles, the determination of gene copy number, etc.). In applied research, the technology is used, e.g., in complex system profiling (e.g., of specific organs and diseases, stress responses, aging, and wound healing), in disease diagnosis, prognosis, and classification, in performing toxicity assessments (e.g., of drugs, foods, environmental conditions, etc.), in functional genomics (e.g., to elucidate metabolic pathways, to study mutations, etc.), and in drug discovery (e.g., to identify and validate targets, to optimize efficacy, etc.).

The throughput of these and other array-based assays can be enhanced, for example, by performing multiple assays simultaneously. However, apparatus and related methods for performing multi-array assays that sufficiently integrate with conventional laboratory equipment are lacking. To illustrate, it would be desirable to deliver multiple fluidic materials from standard micro-well plates to multiple microarrays using standard multi-channel pipetters, laboratory robots, and/or other conventional micro-well equipment in highly automated formats. It would also be desirable to rapidly remove substrates from a reaction device to perform various parallel processes on the microarrays disposed on the substrates in a given multiple microarray-based assay. These and a variety of additional features of the present invention will become evident upon complete review of the following.

### SUMMARY OF THE INVENTION

The present invention provides apparatus and related methods for processing substrate surface features. Surface features typically include samples or other arrayed materials, such as microarrays of oligonucleotides, cDNA, proteins, or the like. More specifically, the invention relates to apparatus that are structured to fluidly separate surface features of substrates that are disposed within the apparatus. For example, multiple microarray-based assays are optionally performed simultaneously on a given substrate disposed within an apparatus of the invention, which significantly enhances assay throughput relative to many pre-existing approaches. In addition, in many embodiments, substrates can be removed from the apparatus to perform various parallel processes on the surface features of the substrates, which further enhances throughput. In preferred embodiments, an assembled apparatus of the invention forms arrays of wells that correspond to wells disposed in commercially available or standard micro-well plates and/or separates multiple surface features disposed on multiple substrates. An apparatus of the invention that includes a footprint that substantially corresponds to that of a standard micro-well plate significantly facilitates, e.g., fluid delivery to the apparatus using pre-existing multi-fluid dispensing devices, translocation of the apparatus using pre-existing robotic systems, placement of the apparatus on pre-existing object holders, and the like. In addition to apparatus, the invention also provides systems and kits that include the apparatus described herein. Furthermore, the invention additionally provides assorted methods of performing multiple array-based assays that utilize the devices and systems of the invention.

In particular, one aspect of the present invention relates to an apparatus for fluidly separating substrate surface features, which apparatus includes at least one separating member that includes at least one array of apertures disposed through the separating member. The array of apertures comprises a footprint that substantially corresponds to a footprint of at least a portion of an array of wells disposed in a micro-well plate. The apparatus also includes at least one supporting member structured to support and align at least one substrate so that when the substrate is supported by the supporting member and the supporting member is mated with the separating member, at least one aperture aligns with at least one surface feature of the substrate to fluidly separate the surface feature from at least one other surface feature of the substrate.

In another aspect, the invention provides an apparatus for fluidly separating substrate surface features, which apparatus includes at least one supporting member structured to support and align two or more substrates. In addition, the apparatus also includes at least one separating member structured to fluidly separate at least two surface features disposed on at least one substrate from one another when the substrates are supported by the supporting member and the supporting member is mated with the separating member. In preferred embodiments, the separating member includes at least one array of apertures disposed through the separating member, which apertures each align with one or more surface features of the substrates to fluidly separate the at least two surface features disposed on each substrate from one another when the substrates are supported by the supporting member and the supporting member is mated with the separating member.

In still another aspect, the invention relates to an apparatus for fluidly separating substrate surface features, which apparatus includes at least one separating member that includes at least one array of apertures disposed through the separating member, which array of apertures comprises a footprint that substantially corresponds to a footprint of at least a portion of an array of wells disposed in a micro-well plate. The apparatus also includes at least one supporting member structured to support and align two or more substrates so that when the substrates are supported by the supporting member and the supporting member is mated with the separating member, apertures align with surface features of the substrates to fluidly separate at least two surface features disposed on at least one substrate from one another.

In the apparatus of the invention, supporting and separating members typically removably mate with one another. For example, the apparatus generally further include one or more fasteners that fasten mated separating and supporting members together. In other embodiments, supporting and separating members are integral (e.g., adhered, bonded, etc. together) with one another. In preferred embodiments, a footprint of the apparatus substantially corresponds to a footprint of a micro-well plate. Apparatus of the invention typically further include at least one sealing component disposed between separating members and substrates to further fluidly separate surface features when substrates are supported by the supporting members and the supporting members are mated with the separating members. In addition, the apparatus described herein typically further include sealing members that are structured to seal separated surface features of the substrates when the sealing members are mated with the apparatus. Optionally, the apparatus of the invention further include a liner that comprises one or more inserts that insert into one or more apertures of separating members.

### BRIEF DESCRIPTION OF THE DRAWINGS

FIG. 1A schematically shows a partially transparent perspective view of one embodiment of an apparatus for fluidly separating substrate surface features of the present invention.

FIG. 1B schematically depicts an exploded perspective view of the apparatus of FIG. 1A.

FIG. 1C schematically illustrates the apparatus of FIG. 1A from a transparent, top plan view.

FIG. 1D schematically shows the apparatus of FIG. 1A from a cutaway, side elevational view.

FIG. 1E schematically depicts the apparatus of FIG. 1A from another cutaway, side elevational view.

FIG. 2A schematically shows the separating member of FIG. 1 from a top plan view.

FIG. 2B schematically depicts the separating member of FIG. 2A from a perspective view.

FIG. 2C schematically illustrates the separating member of FIG. 2A from a cutaway, side elevational view.

FIG. 2D schematically depicts a detailed view from the cutaway, side elevational view of FIG. 2C.

FIG. 2E schematically shows the separating member of FIG. 2A from a bottom plan view.

FIG. 2F schematically shows a detailed view from the bottom plan view of FIG. 2E.

FIG. 2G schematically illustrates a detailed partial cutaway, side elevational view from the separating member of FIG. 2E.

FIG. 3A schematically shows a separating member from a top plan view according to one embodiment of the invention.

FIG. 3B schematically depicts the separating member of FIG. 3A from a perspective view.

FIG. 3C schematically illustrates the separating member of FIG. 3A from a side elevational view.

FIG. 3D schematically depicts a detailed view from the side elevational view of FIG. 3C.

FIG. 3E schematically shows the separating member of FIG. 3A from a bottom plan view.

FIG. 3F schematically shows a detailed view from the bottom plan view of FIG. 3E.

FIG. 3G schematically depicts an exploded top perspective view of a liner and the separating member of FIG. 3A.

FIG. 4A schematically depicts a positioning component of FIG. 1 from a side elevational view.

FIG. 4B schematically shows the positioning component of FIG. 4A from a top plan view.

FIG. 4C schematically illustrates the positioning component of FIG. 4A from a bottom plan view.

FIG. 4D schematically shows the positioning component of FIG. 4A from a perspective view.

FIG. 5A schematically depicts a resilient coupling component of FIG. 1 from a bottom plan view.

FIG. 5B schematically shows the resilient coupling component of FIG. 5A from a side elevational view.

FIG. 5C schematically shows the resilient coupling component of FIG. 5A from a top perspective view.

FIG. 6 schematically illustrates positioning and resilient coupling components positioning a substrate in a detailed view from the cutaway, side elevational view of FIG. 1E.

FIG. 7A schematically shows the supporting member of FIG. 1 from a top plan view.

FIG. 7B schematically depicts the supporting member of FIG. 7A from a perspective view.

FIG. 7C schematically shows a detailed view of the top plan view of FIG. 7A.

FIG. 7D schematically illustrates the supporting member of FIG. 7A from a cutaway, side elevational view.

FIG. 7E schematically depicts a detailed view from the cutaway, side elevational view of FIG. 7D.

FIG. 7F schematically shows the supporting member of FIG. 7A from a bottom plan view.

FIG. 8A schematically illustrates a sealing component of FIG. 1 from a top plan view.

FIG. 8B schematically depicts a detailed view from the sealing component of FIG. 8A.

FIG. 8C schematically depicts a cutaway, side elevational view of a portion of the sealing component of FIG. 8A.

FIG. 8D schematically shows the sealing component of FIG. 8A from a transparent side elevational view.

FIG. 9A schematically shows the sealing member of FIG. 1 from a bottom plan view.

FIG. 9B schematically illustrates a detailed view from the sealing member of FIG. 9A.

FIG. 9C schematically shows the sealing member of FIG. 9A from a side elevational view that includes a cutaway portion.

FIG. 9D schematically depicts a detailed view of the cutaway portion of FIG. 9C.

FIG. 9E schematically illustrates the sealing member of FIG. 9A from a top plan view.

FIG. 10A schematically depicts a substrate of FIG. 1 from a top plan view.

FIG. 10B schematically shows the substrate of FIG. 10A from a side elevational view.

FIG. 11 is a block diagram showing a representative example system for processing substrate surface features in which various aspects of the present invention may be embodied.

### DETAILED DISCUSSION OF THE INVENTION

I. Definitions

Before describing the present invention in detail, it is to be understood that this invention is not limited to particular devices, systems, kits, or methods, which can, of course, vary. It is also to be understood that the terminology used herein is for the purpose of describing particular embodiments only, and is not intended to be limiting. Further, unless defined otherwise, all technical and scientific terms used herein have the same meaning as commonly understood by one of ordinary skill in the art to which the invention pertains. In describing and claiming the present invention, the following terminology and grammatical variants will be used in accordance with the definitions set out below.

An “array” refers to an ordered, regular, or spatially defined pattern, grouping, or arrangement of components. For example, an array of apertures disposed through a separating member of an apparatus of the invention typically includes a spatially defined pattern of apertures of essentially any number (e.g., 2, 4, 6, 12, 24, 48, 96, 192, 384, 1536, or more apertures). For a given number of apertures or wells, alternative spatial patterns are typically possible. To illustrate, a 192-aperture apparatus optionally includes four arrays of 4 rows by 12 columns of apertures (i.e., four 4×12 arrays), four 6×8 arrays, or the like. In preferred embodiments, arrays of apertures, wells, substrate surface features, or the like have footprints that correspond to arrays of wells in commercially available or otherwise standard micro-well plates or other sample containers (e.g., 6 wells in a 3×2 array, 12 wells in 3×4 array, 24 wells in a 6×4 array, 48 wells in a 6×8 array, 96 wells in a 8×12 array, or the like).

A “footprint” refers to the area on a surface covered by or corresponding to a device component or portions thereof. For example, openings to apertures of a separating member or wells of an assembled apparatus that includes substrates of the invention typically correspond to (e.g., fit into, match, align with, etc.) wells in a selected micro-well plate or other sample container. The correspondence is typically one-to-one (e.g., one aperture or well per each well in a micro-well plate, etc.), but is also optionally otherwise (e.g., multiple apertures or wells per each well in a micro-well plate, etc.). In preferred embodiments of the invention, for example, apertures and wells of the apparatus described herein and wells of micro-well plates have substantially the same footprint, such that at least subsets of these wells axially align with one another (e.g., for fluid communication with respect to wells or apertures and wells of micro-well plates, e.g., via standard multi-channel pipetters, etc.). In addition, a footprint of an apparatus component (e.g., a supporting member, a separating member, a sealing member, etc.) also typically substantially corresponds to a footprint of such micro-well plates. To illustrate, one or more of these components typically include external dimensions of between 110 mm and 150 mm× between 70 mm and 110 mm, and more typically between 120 mm and 140 mm× between 80 mm and 100 mm, e.g., 127.7 mm×85.4 mm, or another format.

The term “top” refers to the highest point, level, surface, or part of an apparatus, or apparatus component, when oriented for typical designed or intended operational use, such as dispensing a fluidic material into a well of an apparatus. For example, the separating members of the invention generally include a top surface through which fluid dispensers (e.g., multi-channel pipetters, etc.) access fluidic materials within wells of the apparatus. In contrast, the term “bottom” refers to the lowest point, level, surface, or part of an apparatus, or apparatus component, when oriented for typical designed or intended operational use. To illustrate, a sealing member of the invention typically includes a bottom surface that engages a top surface of a separating member when the two components are mated with one another.

A “surface feature” refers to a particular area, location, or position on a surface of a substrate (e.g., a glass substrate, a polymeric substrate, a membranous substrate, etc.). For example, surface features of substrates of the invention typically include samples (e.g., chemical reagents, cells, cell lysates, or the like), microarrays (e.g., arrays of probe molecules, such as DNA, RNA, peptides, proteins, antibodies, carbohydrates, etc.), or the like. In certain embodiments, surface features are “discrete,” that is, separate or otherwise discontinuous from one another.

The term “engages” refers to the bringing or coming together, interlocking, or meshing of device components. In certain embodiments of the invention, for example, a surface of a supporting member that engages a separating member when the supporting member is mated with the separating member includes recessed regions that are structured to receive and support substrates.

The term “fluidly separate” refers to at least two components that do not fluidly communicate with one another when at least one of the components is contacted with a fluid. In certain embodiments of the invention, for example, at least one aperture of a separating member aligns with at least one surface feature of a substrate to fluidly separate that surface feature from at least one other surface feature of the substrate.

The term “probe” refers to molecules or other components that are arrayed (e.g., synthesized, spotted, etc.) on a substrate. In contrast, the term “target” refers to molecules or other components that are contacted with arrayed probes, e.g., when an array-based assay is performed.

II. Apparatus for Separating Substrate Surface Features

While the present invention will be described with reference to a few specific embodiments, the description is illustrative of the invention and is not to be construed as limiting the invention. Various modifications to the present invention can be made to the preferred embodiments by those skilled in the art without departing from the true scope of the invention as defined by the appended claims. It is noted here that for a better understanding, like components are designated by like reference letters and/or numerals throughout the various figures.

The apparatus of the present invention provide for the delivery of fluids to fluidly separated surface features disposed on substrates positioned within the apparatus and for further processing of those features using, e.g., a variety of commercially available or otherwise standard laboratory equipment. In preferred embodiments, for example, surface features include microarrays of cDNA, oligonucleotides, peptides, small molecules, proteins, antibodies or other capture reagents, which are printed, spotted, or otherwise disposed on glass, plastic, membranes, or other substrates. More specifically, the apparatus described herein provide for the delivery of, e.g., samples, wash buffers, and staining reagents to fluidly separated wells that typically include one or more microarrays at the bottom of each well. The dimensions and configuration of the openings to the wells in the apparatus are generally designed such that the spacing between adjacent wells matches or corresponds to those of wells in commercially available micro-well plates (e.g., 6, 12, 24, 48, 96, 384, 1536, or other micro-well plate formats).

The advantages of the apparatus designs described herein include permitting the use of standard multi-channel pipetters, laboratory robots, and other devices for dispensing/aspirating fluids to/from wells of the apparatus in addition to performing other assay steps or otherwise manipulating the apparatus. For example, the apparatus of the invention permit the automatic washing of microarrays, which increases the robustness of, e.g., various incubation, staining, and washing procedures, thereby significantly enhancing assay throughput relative to pre-existing techniques of processing microarrays. In addition, the substrates used in the apparatus of the invention are often the size of commercially available microscope slides (e.g., 1 inch×3 inches). This further enhances throughput, because most commercial fluorescence scanners, array printers, and the like are designed to accommodate substrates of this size. Moreover, the use of commercial plate washers, for example, produces more uniform washing and processing of microarrays or other arrayed materials, which ultimately improves the quality of assay data. The apparatus of the invention also afford the use of small sample and/or reagent volumes (e.g., 10 μl or less in certain embodiments), which significantly reduces the consumption of these fluidic materials relative to, e.g., more conventional hybridization chambers or the like. The use of smaller sample and/or reagent volumes typically results in significant cost savings, especially when these materials are limiting factors in a given assay. Furthermore, following the delivery of samples to the wells of an apparatus according to the present invention, the apparatus can typically be disassembled to remove the substrates, e.g., to wash the substrates, to image substrate surface features with commercial microarray scanners, etc., which additionally enhances throughput.

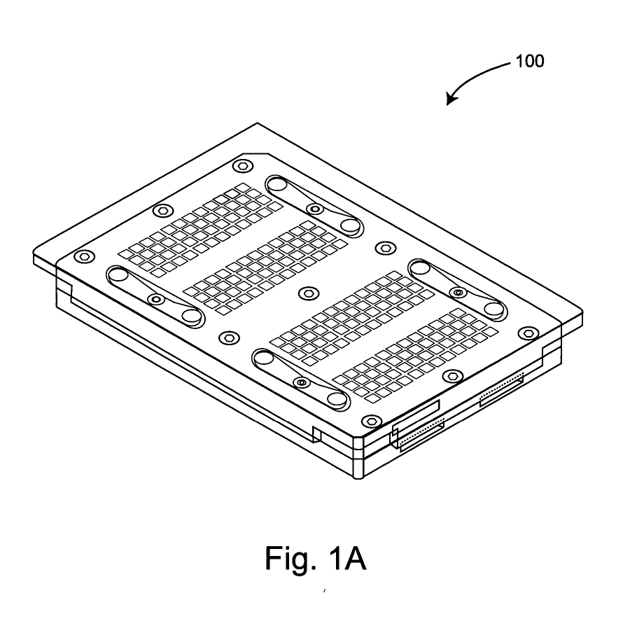

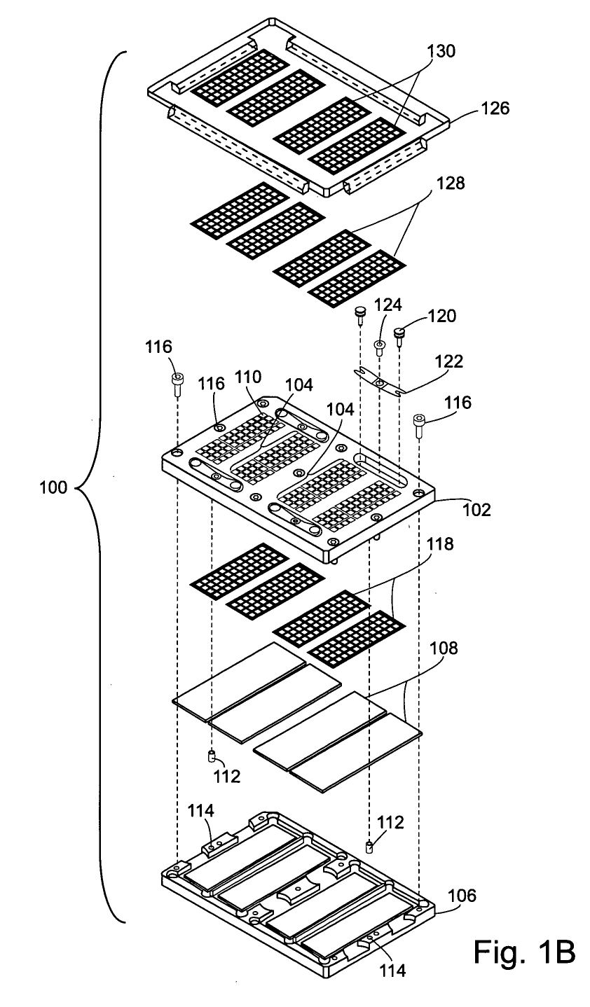

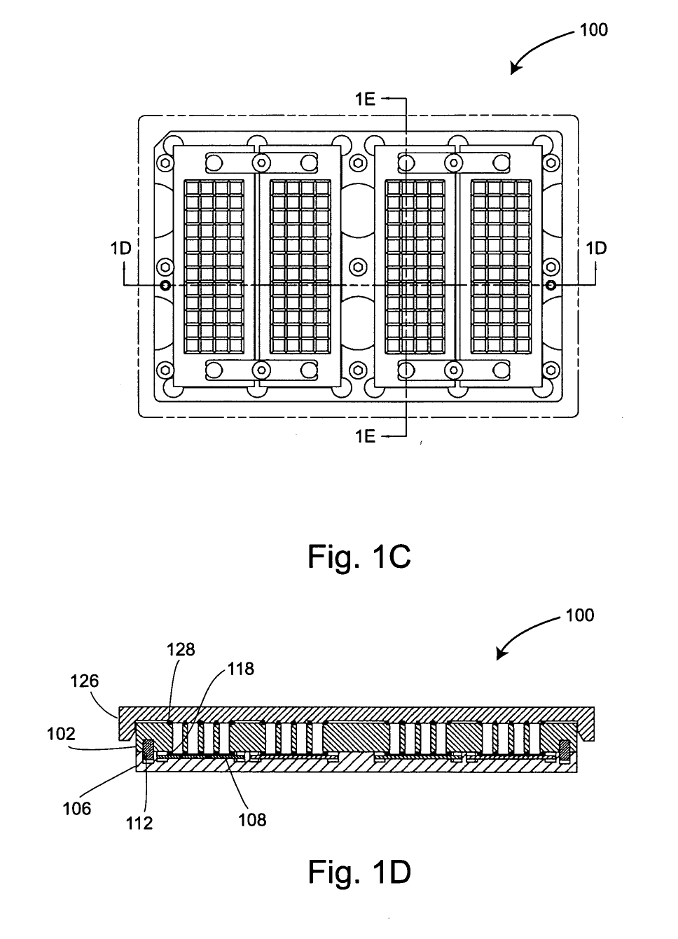

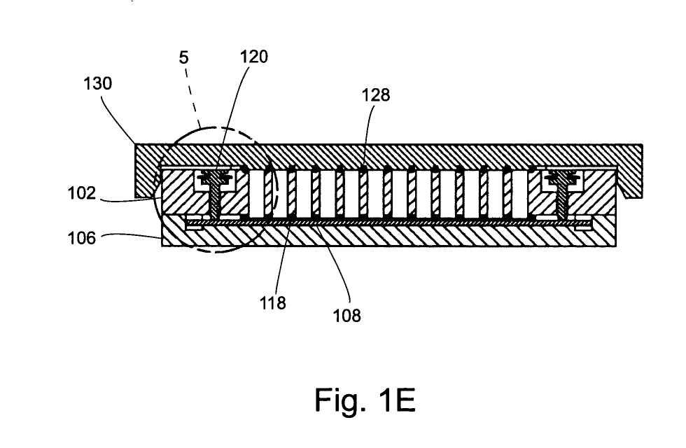

FIG. 1 schematically illustrates an apparatus for fluidly separating substrate surface features according to a preferred embodiment of the invention. In particular, FIG. 1A schematically shows a partially transparent perspective view of assembled apparatus 100, whereas FIG. 1B schematically depicts an exploded perspective view of apparatus 100. As shown, apparatus 100 includes separating member 102, which includes arrays of apertures 104 disposed through the separating member 102. In preferred embodiments, array of apertures 104 corresponds to at least a portion of an array of wells (e.g., the spacing of the wells) disposed in commercially available micro-well plates, which as described above significantly enhances the throughput of, e.g., various microarray-based assays. In addition, a footprint of apparatus 100 also typically substantially corresponds to a footprint of such micro-well plates, e.g., to facilitate handling of apparatus 100 with existing robotic translocation devices, such as a Tecan® robot available from Tecan U.S. (Durham, N.C., USA). Apparatus 100 also includes supporting member 106, which is structured to support substrates 108 so that when substrate 108 is supported by supporting member 106 and supporting member 106 is mated with separating member 102, at least one aperture 110 aligns with at least one surface feature (e.g., including microarrayed materials) of substrate 108 to fluidly separate the surface feature from at least one other surface feature of substrate 108. As shown, separating member 102 is structured to fluidly separate at least two surface features disposed on at least one substrate 108 from one another when substrates 108 are supported by supporting member 106 and supporting member 106 is mated with separating member 102. Arrays of apertures 104 and substrates 108 together form arrays of wells when separating member 102 is mated with supporting member 106.

Although supporting and separating members (106 and 102, respectively) are optionally integral with one another (e.g., glued, bonded, etc. together), in preferred embodiments, supporting and separating members (106 and 102, respectively) removably mate with one another. In these embodiments, supporting member 102 typically includes alignment components 112 (e.g., dowel pins or the like) that correspond to alignment components 114 (e.g., holes, etc.) of separating member 106 to align mated supporting and separating members (106 and 102, respectively). Apparatus 100 generally further includes fasteners 116 (e.g., screws, bolts, clamps, clips, latches, or the like) that fasten mated separating and supporting members (102 and 106, respectively) together. In addition, apparatus 100 typically also includes sealing components 118 (e.g., gaskets, etc.) disposed between separating member 102 and substrates 108 to further fluidly separate surface features when substrates 108 are supported by supporting member 106 and supporting member 106 is mated with separating member 102. In some embodiments, separating member 102 further includes positioning components 120 and resilient coupling component 122 that position substrates 108 relative to separating member 102 when substrates 108 are supported by supporting member 106 and supporting member 106 is mated with separating member 102. Resilient coupling component 122 is typically attached to separating member 102 by fastening component 124. Furthermore, when fasteners 116 are removed from mated separating and supporting members (102 and 106, respectively) that include substrates 108 (e.g., during disassembly of apparatus 100), resilient coupling component 122 provides a force via positioning components 120 to separate substrates 108 from sealing components 118.

As additionally shown, apparatus 100 also typically further includes sealing member 126, which is structured to seal separated surface features of substrates 108 (e.g., disposed in wells of apparatus 100) when sealing member 126 is mated with, e.g., separating member 102, and when substrates 108 are supported by supporting member 106 and supporting member 106 is mated with separating member 102. Apparatus 100 typically also further includes sealing components 128 (e.g., gaskets or the like) disposed between sealing and separating members (126 and 102, respectively) to further seal separated surface features of substrates 108 when sealing member 126 is mated with, e.g., separating member 102 of apparatus 100. A surface of sealing member 126 that engages separating member 102 when sealing member 126 is mated with separating member 102 typically includes recessed grooves 130 that are structured to receive a portion of sealing components 128.

FIG. 1C schematically illustrates assembled apparatus 100 from a transparent, top plan view. FIG. 1D schematically shows the apparatus 100 from a cutaway, side elevational view along cross-section 1D of the view shown in FIG. 1C, whereas FIG. 1E schematically depicts apparatus 100 from another cutaway, side elevational view along cross-section 1E of the view shown in FIG. 1C. Each of the apparatus components introduced above is described in greater detail below.

As described herein, the features or components of apparatus 100 are optionally customized to provide for general utility. For example, different footprints of apparatus 100, or components thereof, are optionally utilized for specialized equipment, e.g., specialized or otherwise non-standard micro-well plates, different fluid handling devices, various robotic systems, or the like. Further, a variety of well formats and numbers are optionally provided, e.g., to increase the volume or numbers of individual wells. In addition, many different gasketing materials are optionally included to efficiently seal the wells depending on, e.g., the contents of the wells and reaction conditions.

A. Separating Members

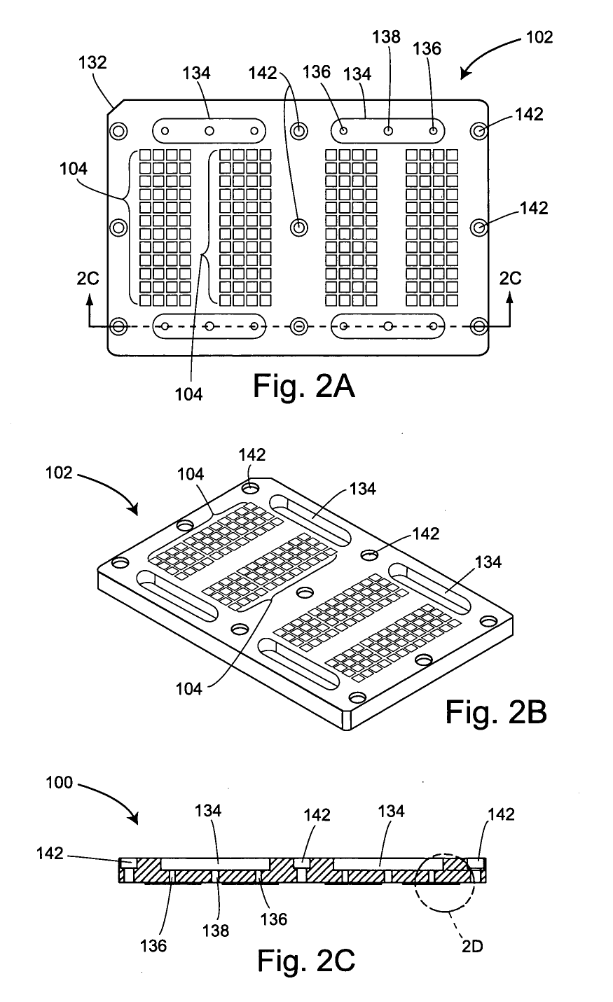

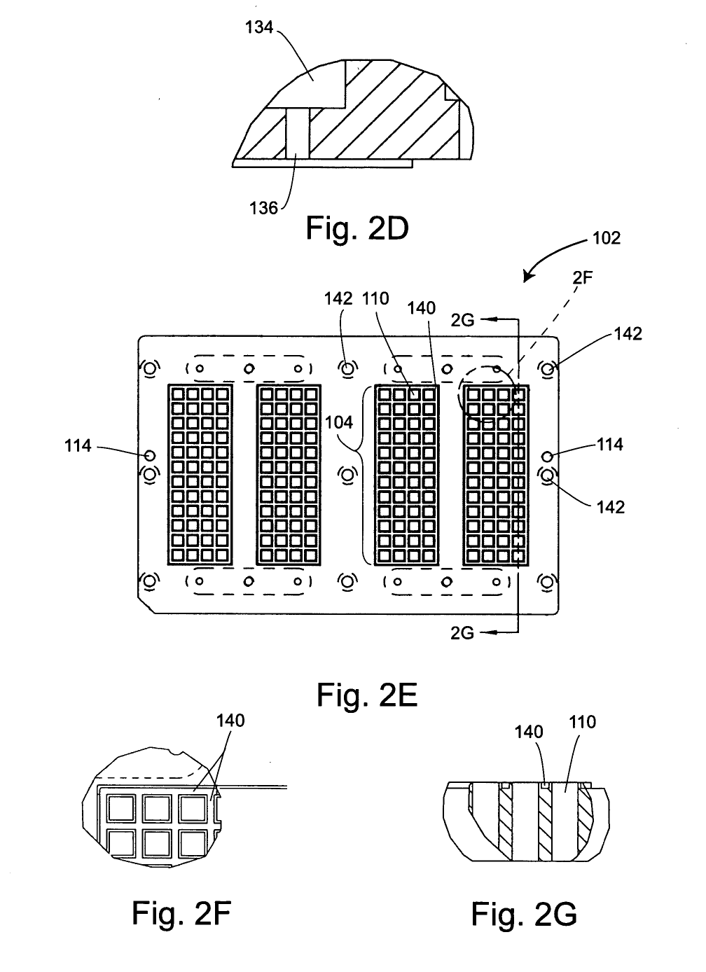

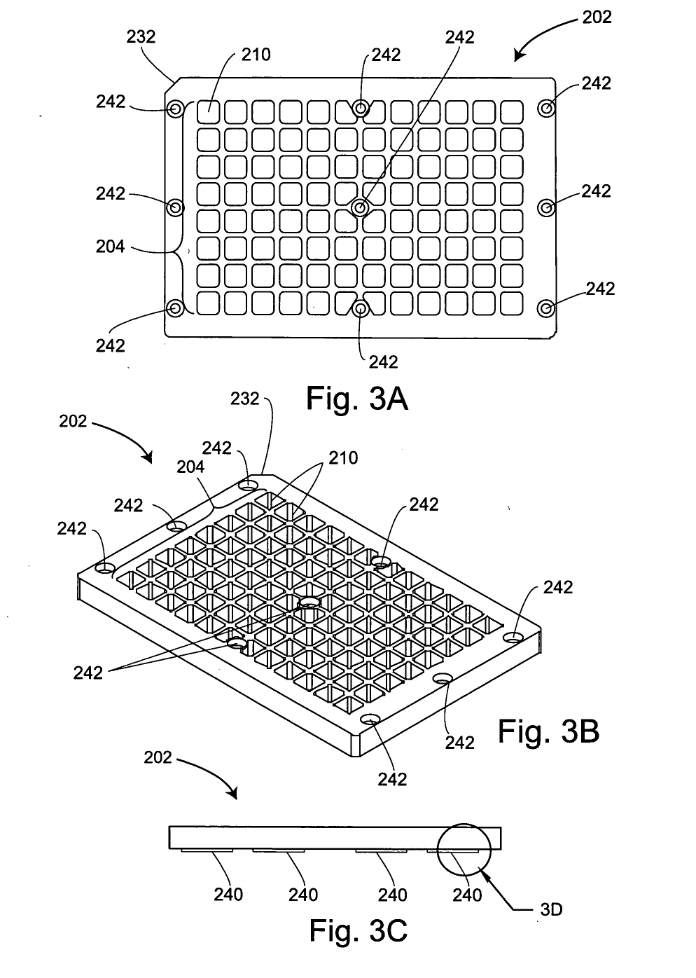

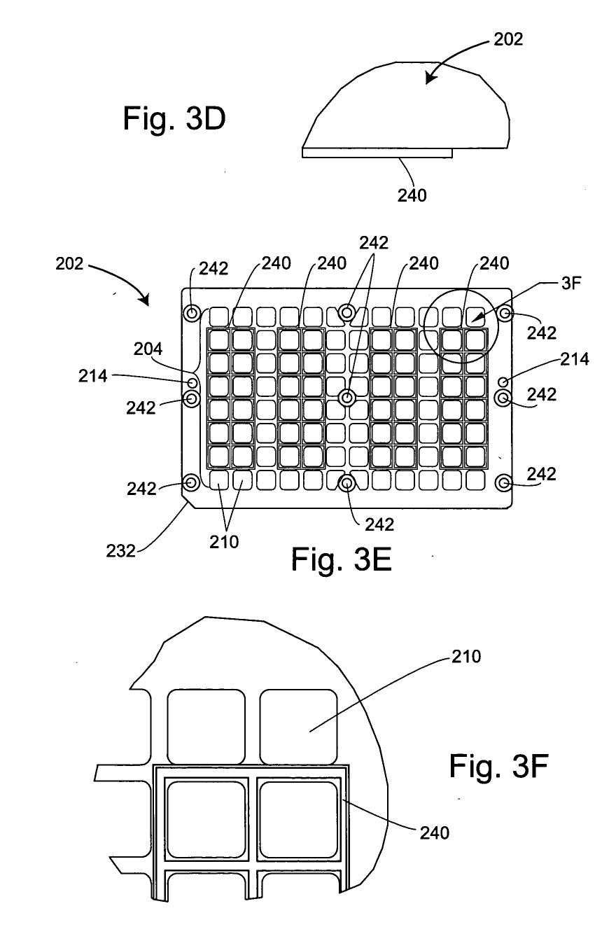

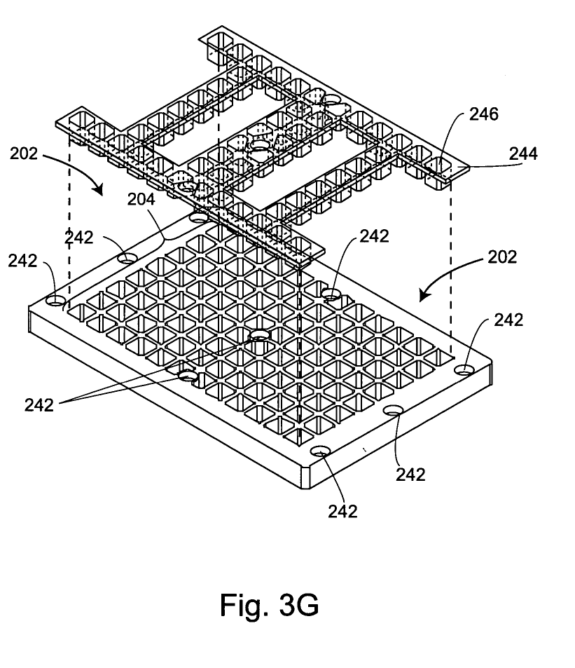

Separating members typically include at least one array of apertures disposed through the separating members to fluidly separate substrate surface features from one another in assembled apparatus that include the substrates. FIG. 2A schematically shows separating member 102 from a top plan view, whereas FIG. 2B schematically depicts the same apparatus component from a perspective view. As shown in the illustrated embodiment, separating member 102 is a grid plate that includes arrays of apertures 104 disposed through separating member 102. While in preferred embodiments, all apertures in an array are disposed completely through a separating member, in others embodiments, fewer than all apertures in a given array are disposed completely through separating members. Although other numbers of aperture arrays are optionally used, the number of arrays of apertures disposed through a separating member typically corresponds to the number of substrates that a supporting member is structured to support (e.g., 1, 2, 3, 4, 5, 6, 7, 8, or more substrates). As shown in FIG. 2A, for example, four arrays of apertures are included in separating member 102 with each array including 48 apertures in 4×12 aperture configurations. To further illustrate, FIGS. 3A-G (described further below) schematically show a separating member that includes an array of apertures that includes 96 apertures in an 8×12 aperture configuration according to another exemplary embodiment of the invention. In addition, essentially any number of apertures within a given array is optionally fabricated in the separating members of the invention. For example, an array of apertures generally includes 6, 12, 24, 48, 96, 192, 384, 1536, or more apertures. In preferred embodiments, the number of apertures in a separating member corresponds to the number of wells disposed in a selected micro-well plate. Furthermore, the number of spacing regions disposed between adjacent apertures, e.g., in a line of apertures of an array of apertures is typically a multiple of the number of spacing regions disposed between adjacent wells in a corresponding line of wells disposed in such a micro-well plate. In addition, centers of adjacent apertures in the array of apertures are optionally spaced, e.g., 18 mm, 9 mm, 4.5 mm, 2.25 mm apart from one another so that they correspond to the center-to-center spacing between adjacent wells in, e.g., 24-, 96-, 384-, or 1536-well micro-well plates, respectively. Other lower or higher density configurations are also optionally utilized.

Separating member apertures may have essentially any cross-sectional shape. To illustrate, at least one aperture in an array of apertures optionally includes a cross-sectional shape selected from, e.g., a regular n-sided polygon, an irregular n-sided polygon, a triangle, a square, a rectangle, a trapezoid, a circle, an oval, and the like. In addition, at least one aperture in the array of apertures typically includes a cross-sectional area of at least 0.1 mm², and more typically of at least 1 mm². In some embodiments of the invention, for example, apertures in a given array of apertures have cross-sectional areas of 9 mm² (e.g., 3 mm×3 mm squares) with 4.5 mm center-to-center spacing between adjacent apertures in the array.

Arrays of apertures and substrates together form arrays of wells when separating members are mated with supporting members, that is, when apparatus are assembled and include substrates. A well in an array of wells typically includes a volume capacity of between 0.1 μl and 1000 μl, more typically between 1 μl and 500 μl, and still more typically between 1 μl and 100 μl. Although each well in an array of wells generally includes the same volume capacity, in some embodiments wells in one array have different volume capacities from those in other well arrays, or at least one well in a given array of wells has a different volume capacity from other wells in the array.

In certain embodiments, separating members include one or more positioning components that position or otherwise orient substrates relative to the separating and/or supporting members, e.g., when the substrates are supported by supporting members and supporting members are mated with separating members. As described further below, supporting members also optionally include positioning components. In preferred embodiments, positioning components are resiliently coupled to, e.g., separating members by resilient coupling components (e.g., metallic or polymeric strips or bands having a selected flexure or tension (e.g., leaf springs, etc.), springs, or the like).

As shown in FIGS. 2A and B, in some embodiments, separating member 102 is fabricated with recessed regions 134 within which positioning and resilient coupling components are optionally mounted. FIG. 2C schematically illustrates separating member 102 from a cutaway, side elevational view along cross-section 2C of the view shown in FIG. 2A. As shown, recessed regions 134 include holes 136 and 138 disposed at least partially through separating member 102. Holes 136 typically receive positioning components 120, e.g., to guide positioning components 120 into contact with substrates in an assembled apparatus. FIG. 2D schematically depicts detailed view 2D from the cutaway, side elevational view of FIG. 2C to further show hole 136 and a portion of recessed region 134. Fastening components 124 are typically inserted into holes 138 to attach resilient coupling components 122 to separating member 102.

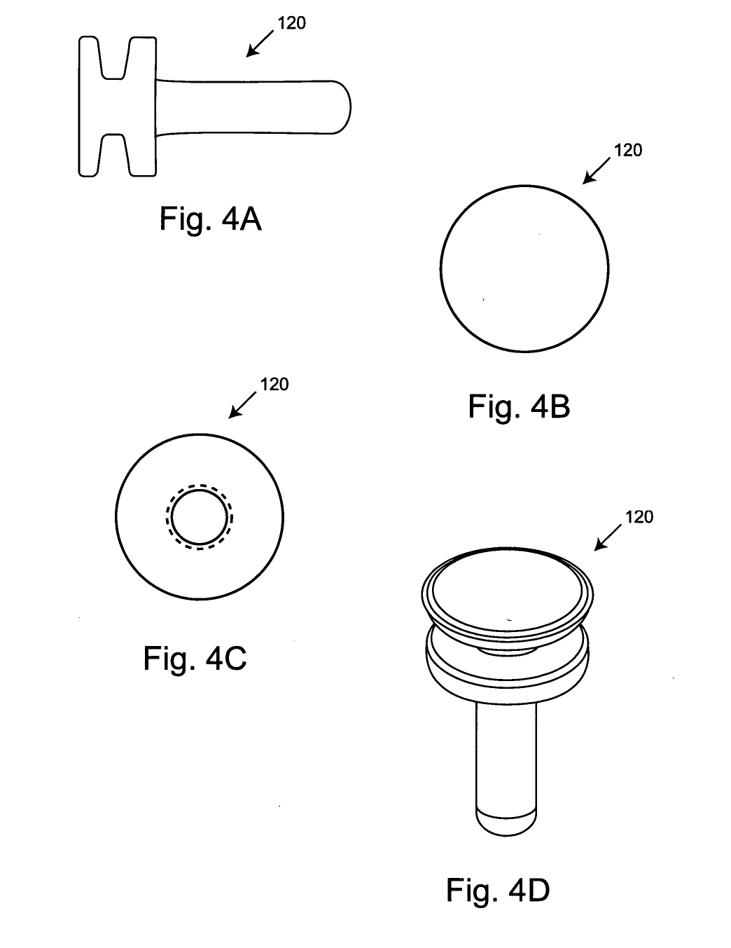

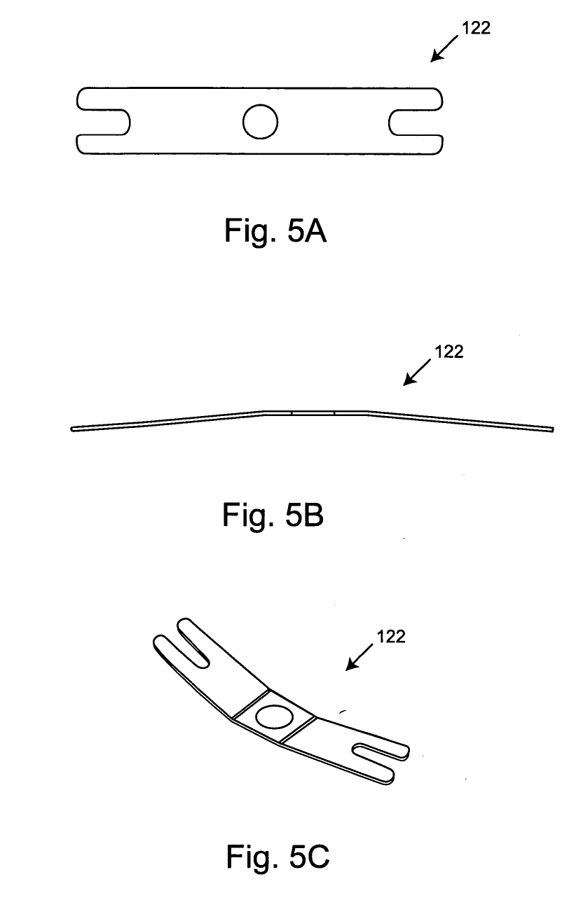

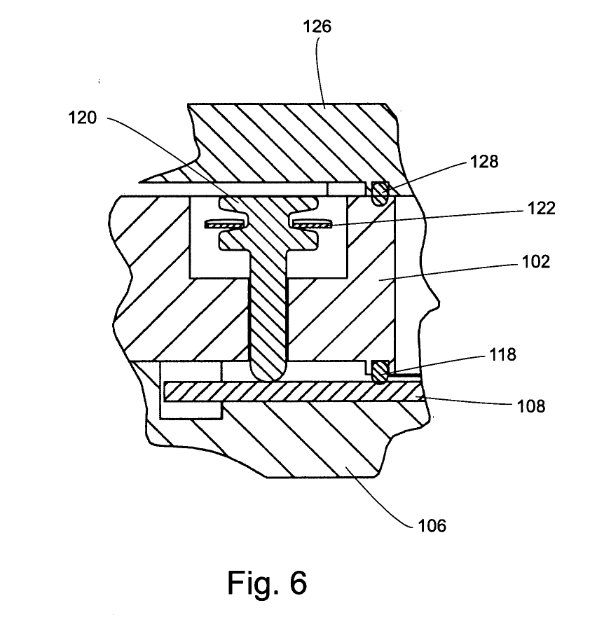

FIGS. 4 and 5 further illustrate embodiments of positioning and resilient coupling components of the invention from various views. In particular, FIG. 4A schematically depicts positioning component 120 from a side elevational view, while FIG. 4B schematically shows positioning component 120 from a top plan view. In addition, FIG. 4C schematically illustrates positioning component 120 from a bottom plan view and FIG. 4D schematically shows the component from a perspective view. Furthermore, FIG. 5A schematically depicts resilient coupling component 122 from a bottom plan view, FIG. 5B schematically shows the component from a side elevational view, and FIG. 5C schematically shows the component from a top perspective view. FIG. 6 schematically illustrates positioning and resilient coupling components (120 and 122, respectively) positioning substrate 108 in a detailed view from the cutaway, side elevational view of FIG. 1E.

In preferred embodiments, a surface of a separating member that engages a supporting member when the separating member is mated with the supporting member includes one or more recessed grooves that are structured to receive a portion of a sealing component. For example, depths of recessed grooves in separating members and depths of recessed regions in supporting members that are structured to support substrates are both typically fabricated to optimally compress sealing components between separating members and substrates when the substrates are supported by supporting members and supporting members are mated with separating members. Sealing members are described in greater detail below. To further illustrate, FIG. 2E schematically shows separating member 102 from a bottom plan view. As shown in the illustrated embodiment, recessed grooves 140 are disposed around each aperture 110 in array of apertures 104. FIG. 2F schematically shows detail view 2F from the bottom plan view of FIG. 2E to further illustrate recessed grooves 140. In addition, FIG. 2G schematically illustrates a detailed partial cross-sectional cutaway, side elevational view 2G from separating member 102 of FIG. 2E that also shows recessed grooves 140.

As mentioned above, in preferred embodiments of the invention, separating and supporting members removably mate with one another so that, e.g., substrates can be removed from an apparatus to perform various parallel processes on microarrayed materials disposed on the substrates. Parallel processes such as blocking, washing, and staining are described in greater detail below. Separating and supporting members are typically removably mated to one another using various types of fasteners, such as screws, bolts, clamps, clips, latches, or the like. To illustrate one embodiment, FIGS. 2A and E, for example, show holes 142 through which fasteners 116 are inserted to attach separating member 102 to supporting member 106. In some embodiments, separating and supporting members are integral with one another such that substrates are generally not removable from an apparatus. In these embodiments, separating and supporting members are typically adhered, bonded, riveted, bolted, welded, or otherwise made integral with one another.

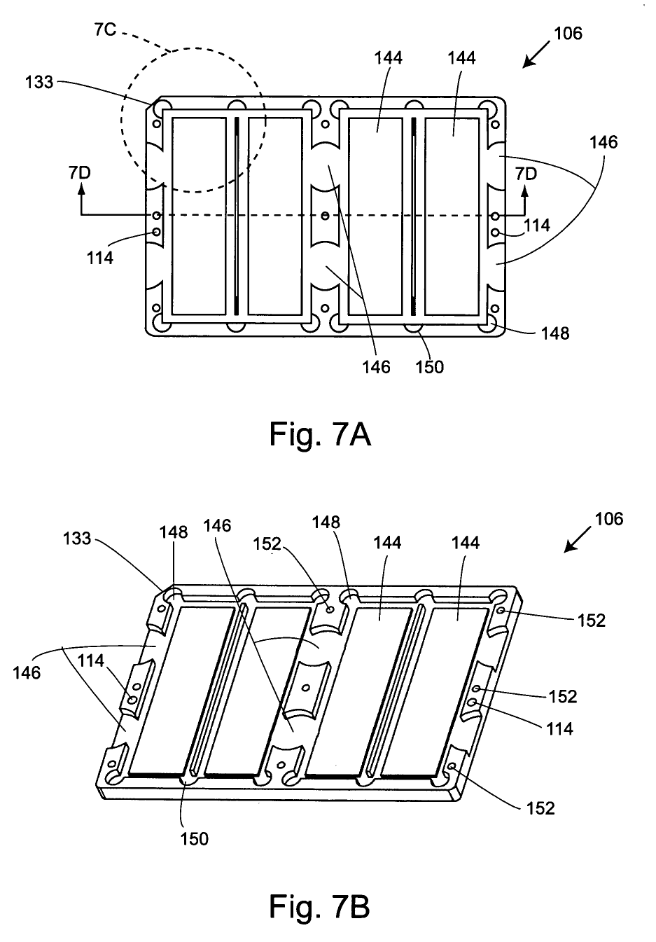

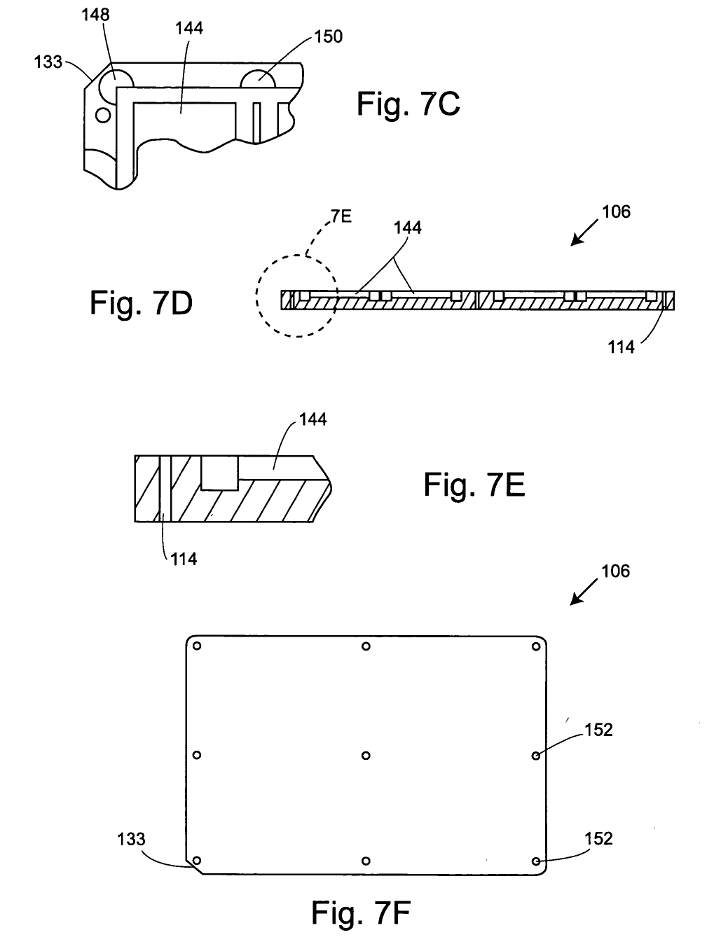

Separating members of the apparatus of the present invention optionally include various alignment components or features that align separating members with other components of the apparatus and/or with other devices with which the apparatus is used. As mentioned above, for example, supporting members typically include corresponding alignment components that align mated supporting and separating members. One embodiment of these components is schematically illustrated in FIG. 1B, which shows the components as corresponding pairs of pins and holes (112 and 114, respectively). Other corresponding pairs of alignment components, such as corresponding pairs of elevated ridges and receiving indentations are also optionally utilized. Apparatus of the invention also optionally include alignment features that align, e.g., mated separating and supporting members with positioning platforms, object holders, or the like. FIG. 2A schematically illustrates one embodiment of such a feature for separating member 102, namely, alignment feature 132. A similar alignment feature (i.e., alignment feature 133) is schematically depicted in FIG. 7A for supporting member 106. Object holders that are optionally adapted for use with the apparatus of the present invention are described in, e.g., International Publication No. WO 01/96880, entitled “AUTOMATED PRECISION OBJECT HOLDER,” by Mainquist et al., which is incorporated by reference in its entirety for all purposes. The apparatus of the invention are also optionally fabricated with various other alignment components including, e.g., extended or modeled edges that align with robotic gripping devices for gripping and translocating the apparatus between object holders, work stations, or the like. Robotic gripping devices that are optionally adapted for use with the apparatus of the present invention are described further in, e.g., U.S. Pat. No. 6,592,324, entitled “GRIPPER MECHANISM,” issued Jul. 15, 2003 to Downs et al., and International Publication No. WO 02/068157, entitled “GRIPPING MECHANISMS, APPARATUS, AND METHODS,” by Downs et al., which are both incorporated by reference in their entirety for all purposes.

To illustrate other embodiments, FIG. 3A schematically shows separating member 202 from a top plan view, whereas FIG. 3B schematically depicts separating member 202 from a perspective view. As shown, separating member 202 is a grid plate that includes array of apertures 204 disposed through separating member 202. Array of apertures 204 includes 96 apertures 210 in an 8×12 configuration. In this embodiment, apertures 210 of array of apertures 204 typically comprise approximately 7.5 mm² cross-sectional dimensions and the centers of adjacent apertures 210 are generally spaced about 9 mm apart from one another. Holes 242 are also disposed through separating member 202. Fasteners 116 are inserted through holes 242 to attach separating member 202 to supporting member 106. In addition, separating member 202 also includes alignment feature 232, which aligns separating member 202 with, e.g., a supporting member, a sealing member, and/or another device, as described herein. FIG. 3C schematically illustrates separating member 202 from a side elevational view, while FIG. 3D schematically depicts a detailed view from the side elevational view of FIG. 3C.

To further illustrate, FIG. 3E schematically shows separating member 202 from a bottom plan view. As also shown, separating member 202 includes alignment components 214, which receive alignment components 112 to align mated supporting and separating members (106 and 202, respectively). In addition, FIG. 3E also shows recessed grooves 240 disposed around certain apertures 210. Recessed grooves 240 are structured to receive corresponding sealing components (not shown). In an assembled apparatus comprising separating member 202, the sealing components (four in this embodiment) are disposed between separating member 202 and substrates 108 in recessed grooves 240 of separating member 202 to fluidly separate surface features (e.g., comprising microarrays, etc.) of substrates 108 from one another. FIG. 3F schematically shows a detailed view from the bottom plan view of FIG. 3E.

FIG. 3G schematically depicts an exploded top perspective view of liner 244 and separating member 202. In an assembled apparatus that includes separating member 202, liner 244 is typically disposed in apertures 210 that do not include recessed grooves 240 disposed around those apertures 210 on the bottom surface of separating member 202. In certain embodiments, liners are utilized, which insert into fewer apertures 210 than shown in FIG. 3G. Liner 244 prevents fluids and other materials from accessing apertures 210 within which inserts 246 of liner 244 are disposed. Liner 244 is optionally fabricated from a wide variety of materials including, e.g., rubber, plastic, and the like. In the embodiment shown in FIG. 3G, cavities are formed in inserts 246 of liner 244. These cavities are optionally utilized to contain materials as desired. In other embodiments, inserts 246 lack these cavities.

B. Supporting Members

The apparatus for separating substrate surface features of the invention include supporting members that are structured to support at least one substrate. Typically, supporting members are structured to support multiple substrates. When substrates are supported by supporting members and the supporting members are mated with separating members, at least one aperture of the separating members typically aligns with at least one surface feature of the substrates to fluidly separate the surface feature from at least one other surface feature of the substrates. In preferred embodiments, supporting members are structured to support substrates that are removable from the supporting members when separating members are not mated with the supporting members. For example, supporting members are optionally structured to support 1, 2, 3, 4, 5, 6, 7, 8, or more removable substrates. In these embodiments, surfaces of the supporting members that engage the separating members when the supporting members are mated with the separating members (e.g., a top surface of the supporting members) typically include one or more recessed regions that are structured to receive and support one or more substrates. Recessed regions are typically machined or otherwise fabricated to closely correspond to the dimensions of the substrates to be received so that the positions of surface features on the substrate can be accurately held with respect to apertures in separating members. To illustrate, supporting members optionally are fabricated to include, e.g., 1, 2, 3, 4, 5, 6, 7, 8, or more recessed regions. In certain embodiments, the supporting member includes at least two datum surfaces that are structured to align a substrate relative to an array of apertures when the supporting member supports the substrate and the supporting member is mated with the separating member. In some of these embodiments, for example, surfaces of the recessed regions function as these datum surfaces. As addition options, substrates are integral with supporting members, e.g., fabricated as part of the supporting members, or glued, bonded or otherwise attached to supporting members after the respective components have been manufactured, e.g., in separate processes.

FIG. 7A schematically shows supporting member 106 from a top plan view, while FIG. 7B schematically depicts the supporting member 106 from a perspective view. In an additional view, FIG. 7F schematically shows supporting member 106 from a bottom plan view. As shown, supporting member 106 is fabricated as a supporting plate, the top surface of which includes four recessed regions that are each structured to receive and support a separate substrate (e.g., a microscope slide, etc.) that is removable from supporting member 106. In certain embodiments, supporting members are manufactured with one or more access features that allow access to substrates disposed in the recessed regions when the separating members are not mated with supporting members. Further, in some embodiments, these access features also facilitate fluid drainage from supporting members, e.g., when separating and supporting members are disassembled or unmated after an assay is performed or the like. To illustrate, as further shown in FIGS. 7A and B, supporting member 106 includes access features 146, 148, and 150, respectively, that permit a user, e.g., to remove and/or place substrates from/into recessed regions 144 when apparatus 100 is disassembled. Datum surfaces 145 align substrates relative to, e.g., arrays of apertures 104 of separating member 102 when supporting member 106 and separating member 102 are mated with one another. FIG. 7C schematically shows detailed view 7C of the top plan view of FIG. 7A. In other views, FIG. 7D schematically illustrates supporting member 106 from a cutaway, side elevational view along cross-section 7D of the view shown in FIG. 2A, while FIG. 7E schematically depicts detailed view 7E from the cutaway, side elevational view of FIG. 7D.

As mentioned above, supporting members typically include alignment components that correspond to alignment components (e.g., corresponding pairs of dowel pins and holes or the like) on separating members, e.g., to align mated supporting and separating members. In FIGS. 7A and B, for example, supporting member 106 includes holes 114 that receive corresponding pins 112 to align supporting member 106 with separating member 102. In embodiments, where separating members are removable from supporting members, the supporting members also typically include one or more components for fastening or otherwise removably attaching separating and supporting members together. To illustrate, in FIGS. 7A and B supporting member 106 includes holes 152 that correspond to holes 142 of separating member 102 which receive fasteners 116 to removably attach separating member 102 to supporting member 106.

Although not shown in FIG. 7, in certain embodiments, supporting members include one or more orifices through which detectable signals (e.g., radioactive emissions, fluorescent emissions, etc.) that are produced on substrates disposed in the apparatus are detected. Detectors and other system components are described in greater detail below. Also not shown, but which are optionally included in the supporting members of the invention are various positioning components, such as clips that position substrates relative to supporting and/or separating members. Positioning and resilient coupling components are also described above.

C. Sealing Components

Apparatus of the invention typically also each include at least one sealing component disposed between separating members and substrates, e.g., to further fluidly separate surface features when the substrates are supported by supporting members and supporting members are mated with separating members. In preferred embodiments, for example, sealing components of the apparatus of the invention are gaskets. Gaskets are typically disposable or consumable components of the apparatus of the invention. In particular, gaskets suitable for use in the apparatus of the present invention are optionally made from essentially any chemically resistant rubber or elastomeric material (e.g., low durometer materials), many of which are well known in the art. For example, suitable gaskets are optionally fabricated from, e.g., silicon (commercially available from, e.g., Minnesota Rubber (Minneapolis, Minn., USA)), Viton®, Santoprene®, Teflon®, Gore-Tex®, Celerus™, or the like. Many of these materials are readily available from various commercial suppliers, such as W L. Gore & Associates (Newark, Del., USA). Combinations of materials, e.g., in the form of composites or laminates are also optionally utilized as sealing components in the devices of the invention. Gasket materials are typically selected based upon their abilities to maintain seals without leakage of fluidic materials even after repeated exposure to such materials.

In some embodiments, gaskets or other sealing components are formed around each aperture in arrays of apertures of separating members, whereas in others, sealing components are integral (e.g., bonded or otherwise attached) with separating members. Typically, at least portions of sealing components include cross-sectional shapes (e.g., circular, oval, or the like) that allow sealing to occur on multiple sides of the sealing components when the sealing components are subjected to compressive loads. That is, sealing components of the invention typically have semi-circular sealing profiles on top and bottom portions of the sealing components. In preferred embodiments, separate gaskets or other sealing components that correspond to each of the substrates are disposed between separating members and the substrates when multiple substrates are supported by supporting members and supporting members are mated with separating members. For example, in some embodiments, 1, 2, 3, 4, 5, 6, 7, 8, or more separate sealing components are utilized, e.g., depending on the number of substrates supported in a particular apparatus.

As described above, surfaces of separating members that engage supporting members when separating members are mated with the supporting members typically include one or more recessed grooves that are structured to receive a portion of the sealing component. Further, a depth of the recessed grooves in the separating members and a depth of recessed regions in the supporting members that are structured to support the substrates generally optimally compress the sealing components between the separating members and the substrates when the substrates are supported by the supporting members and the supporting members are mated with the separating members. In certain embodiments, the apparatus of the invention further include at least one sealing component disposed between top surfaces of separating members and bottom surfaces of sealing members to further seal the arrays of wells disposed within a given apparatus. Sealing members and related sealing components are described further below.

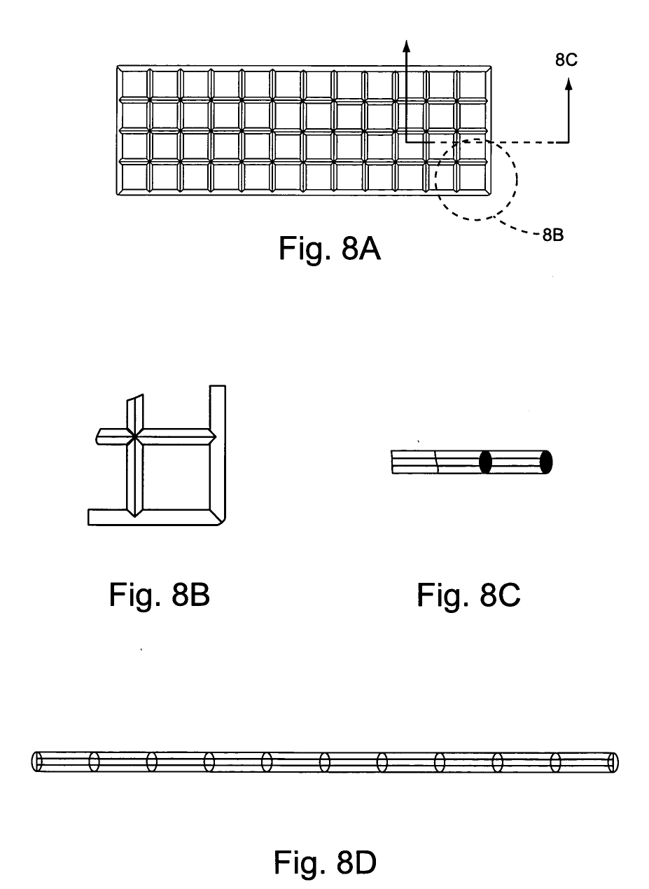

FIG. 8A schematically illustrates a sealing component, such as those schematically depicted in FIG. 1 (i.e., sealing components 118 and 128, respectively) from a top plan view. As shown, the depicted sealing component is designed for use with an array of apertures that includes 48 members in a 4×12 array, such as array of apertures 104 that is schematically illustrated in, e.g., FIG. 2E. In other views, FIG. 8B schematically depicts detailed view 8B from the sealing component of FIG. 8A, whereas FIG. 8C schematically depicts a cutaway, side elevational view along cross-section 8C of the view shown in FIG. 8A. In an additional view, FIG. 8D schematically shows the sealing component of FIG. 8A from a transparent side elevational view.

D. Sealing Members

In some embodiments, the apparatus further includes at least one sealing member (e.g., a lid, a cover, or the like) structured to seal at least one separated surface feature of one or more substrates when the sealing member is mated with the apparatus, e.g., when the substrates are supported by the supporting member and the supporting member is mated with the separating member. In preferred embodiments, a footprint of the sealing member substantially corresponds to a footprint of a micro-well plate. Optionally, sealing members are removably attached to, e.g., assembled separating and supporting members by, e.g., one or more sets of hinges (e.g., lift-off hinges, etc.) and/or latches.

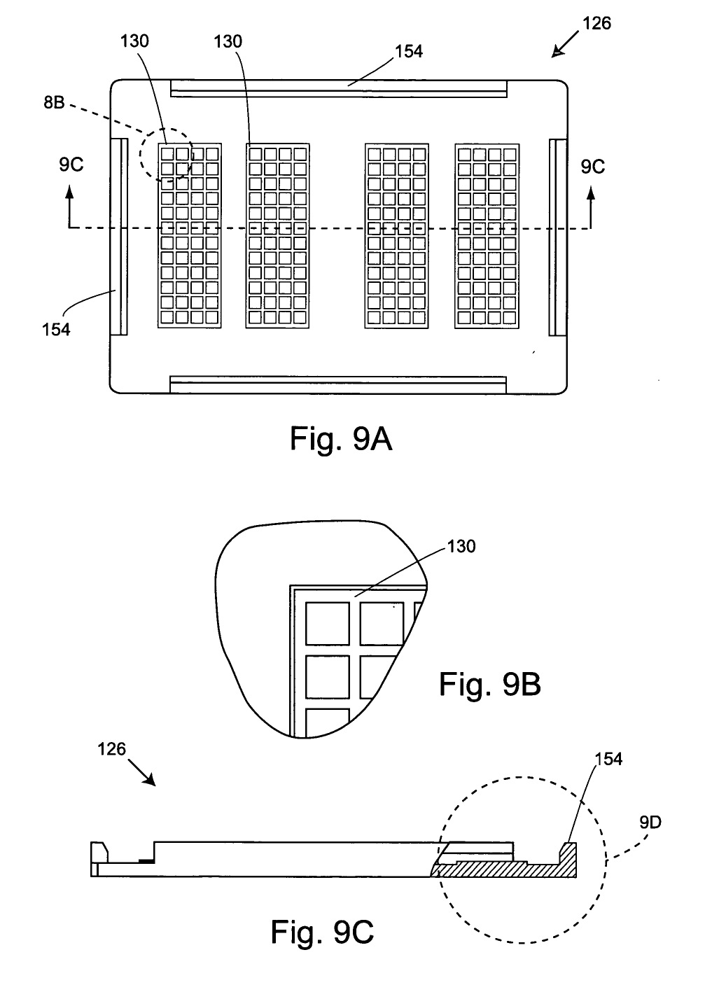

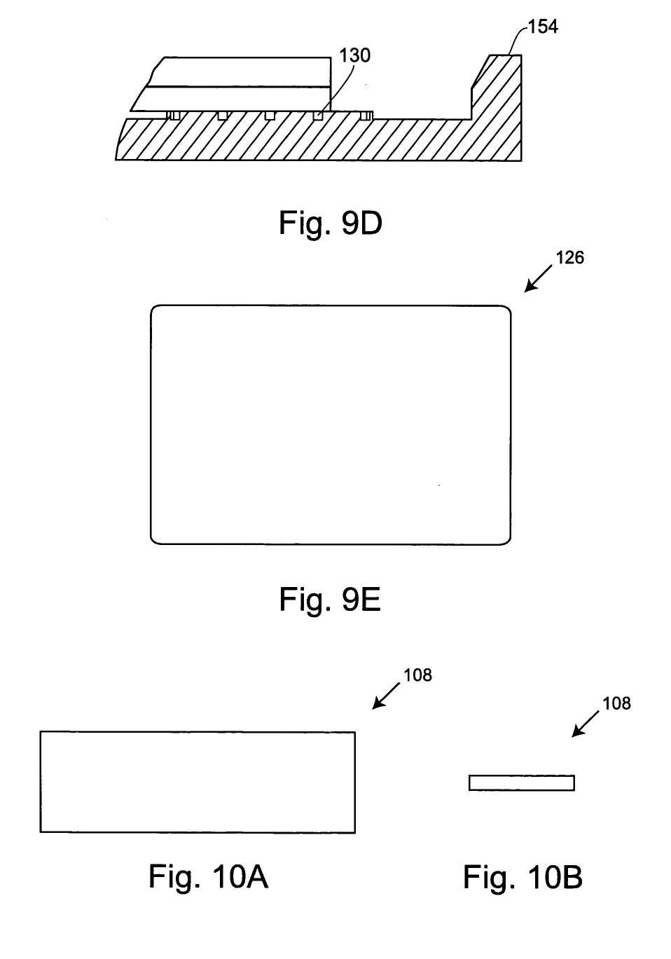

FIG. 9A schematically shows sealing member 126 from a bottom plan view, while FIG. 9E schematically illustrates sealing member 126 from a top plan view. As mentioned above, in certain embodiments, an apparatus of the invention further includes at least one sealing component (e.g., a gasket or the like) disposed between sealing and separating members, e.g., to further seal separated surface features of the substrates when the sealing member is mated with the apparatus. In these embodiments, a surface (e.g., a bottom surface) of the sealing member that engages the separating member when the sealing member is mated with the separating member typically includes one or more recessed grooves that are structured to receive a portion of the sealing component. As shown in FIG. 9A, sealing member 126 includes recessed grooves 130, which are structured to receive sealing components, e.g., like the gasket depicted in FIG. 8A. FIG. 9B schematically illustrates detailed view 9B from the sealing member of FIG. 9A, which further shows a portion of recessed grooves 130. In some embodiments of the invention, top surfaces of separating members include one or more recessed grooves disposed around apertures in the arrays of apertures (e.g., in addition to the recessed grooves of the sealing member, or instead of the recessed grooves of the sealing member), which recessed grooves are structured to receive portions of sealing components. Sealing components are optionally integral with or separate from sealing members. In preferred embodiments, separate sealing components that correspond to each substrate are disposed between the separating and sealing members. In these embodiments, for example, 1, 2, 3, 4, 5, 6, 7, 8, or more separate sealing components are typically disposed between the separating and sealing members. At least portions of sealing components typically include cross-sectional shapes (e.g., circular, oval, etc.) that allow sealing to occur on multiple sides of the sealing component when the sealing component is subjected to a compressive load.

In some embodiments, sealing components are sheets of gasketing material. In certain of these embodiments, the sheets of gasketing material are fabricated with at least one protrusion disposed on a surface, which protrusion axially aligns with, e.g., an inlet to an aperture of a separating member. Such protrusions are included to further effect seals of wells in the apparatus of the invention. In these embodiments, the at least one protrusion typically includes an array of protrusions in which each protrusion in the array axially aligns with a different aperture in an array of apertures of a separating member. Gasketing sheets that include protrusions, which are optionally adapted for use with the apparatus of the present invention are described further in, e.g., U.S. Patent Application Pub. No. 2003/0044324, entitled “PARALLEL REACTION DEVICES,” by Micklash et al., filed Sep. 5, 2001, which is incorporated by reference in its entirety for all purposes. Additional details regarding sealing components of the apparatus of the invention are also described above.

The sealing members of the invention typically include one or more alignment features to align the sealing members with other components of the apparatus (e.g., mated separating and supporting members) and/or another device, such as an object holder, a robotic gripper mechanism, or the like. For example, sealing member 126 of FIG. 9A includes alignment features 154 that align sealing member 126 with, e.g., separating member 102. Other views of alignment features 154 are provided in FIG. 9C, which schematically shows sealing member 126 from a side elevational view that includes a cutaway portion along cross-section 9C from FIG. 9A. In addition, FIG. 9D schematically depicts detailed view 9D of the cutaway portion of FIG. 9C.

The components of an apparatus of the invention (e.g., such as the embodiment depicted in the accompanying figures) are optionally assembled by placing substrates 108 into recessed regions 144 of supporting member 106. Datum surfaces 145 align substrates 108 relative to, e.g., array of apertures 104 of separating member 102 when separating member 102 and supporting member 106 are mated with one another. Thereafter, sealing components 118 are inserted into recessed grooves 140 of separating member 102, which is then aligned with supporting member 106 using pins 112. Separating member 102 is pushed down onto supporting member 106 until sealing components 118 contact substrates 108. Fasteners 116 are then typically installed to more securely fluidly separate surface features of substrates 108 from one another, e.g., in preparation for performing multiple-array based assays or other fluid processing procedures. Optionally, sealing components 128 are inserted into recessed grooves 130 of sealing member 126, which is then placed on top of separating member 102, e.g., to minimize evaporation and the risk of contamination during hybridization or incubation processes, apparatus storage, or the like.

E. Substrates

The apparatus of the present invention fluidly separate surface features of various types of substrates. For example, apparatus of the invention are optionally customized to accommodate essentially any substrate size and essentially any number of substrates. In preferred embodiments, at least one of the substrates disposed within an apparatus described herein includes a surface having a surface area of at least 1875 mm², that is, a surface area of a standard (1 inch×3 inch) microscope slide. To illustrate, FIG. 10A schematically depicts a substrate 108 from a top plan view, whereas FIG. 10B schematically shows substrate 108 of FIG. 10A from a side elevational view. In other embodiments, substrates have smaller or larger surface areas. To illustrate, in some embodiments, substrates utilized in the apparatus of the invention have surface areas between 10 mm² and 108 mm², typically between 100 mm² and 107 mm², more typically between 500 mm² and 106 mm², and still more typically between 1000 mm² and 105 mm². In addition, apparatus of the invention are optionally designed to accommodate, e.g., 1, 2, 3, 4, 5, 6, 7, 8, or more separate substrates. In some embodiments, each substrate in a particular device includes a surface having the same area, whereas in other embodiments, at least one substrate in an apparatus of the invention includes a surface area that is different from that of another substrate in the apparatus.

Essentially any substrate material is optionally adapted for use in the apparatus of the invention. In certain embodiments, for example, substrates are fabricated from silicon, glass, or polymeric materials (e.g., glass or polymeric microscope slides, silicon wafers, etc.). Suitable glass or polymeric substrates, including microscope slides, are available from various commercial suppliers, such as Fisher Scientific (Pittsburgh, Pa., USA) or the like. Optionally, substrates utilized in the apparatus of the invention are membranes. Suitable membrane materials are optionally selected from, e.g. polyaramide membranes, polycarbonate membranes, porous plastic matrix membranes (e.g., POREX® Porous Plastic, etc.), porous metal matrix membranes, polyethylene membranes, poly(vinylidene difluoride) membranes, polyamide membranes, nylon membranes, ceramic membranes, polyester membranes, polytetrafluoroethylene (TEFLON™) membranes, woven mesh membranes, microfiltration membranes, nanofiltration membranes, ultrafiltration membranes, dialysis membranes, composite membranes, hydrophilic membranes, hydrophobic membranes, polymer-based membranes, a non-polymer-based membranes, powdered activated carbon membranes, polypropylene membranes, glass fiber membranes, glass membranes, nitrocellulose membranes, cellulose membranes, cellulose nitrate membranes, cellulose acetate membranes, polysulfone membranes, polyethersulfone membranes, polyolefin membranes, or the like. Many of these membranous materials are widely available from various commercial suppliers, such as, P J. Cobert Associates, Inc. (St. Louis, Mo., USA), Millipore Corporation (Bedford, Mass., USA), or the like.

Surfaces of substrates used in the apparatus of the present invention typically include surface features (e.g., arrays of surface features) having probe molecules, samples, or the like disposed thereon. In preferred embodiments, surface features include microarrays. For example, the microarrays typically include arrayed probe molecules that are optionally selected from, e.g., organic molecules, inorganic molecules, oligonucleotides, polynucleotides, DNA (e.g., PCR products produced from cDNA clones, etc.), RNA, peptide nucleic acids, peptides, polypeptides, proteins, antibodies, sugars, saccharides, polysaccaharides, carbohydrates, and the like. As additional options, surface features of the substrates include samples, such as chemical reagents, cells, cell lysates, or the like. Additional details relating to microarrays, arrayed sample materials, and related assays are described below.

The surface features of the substrates utilized in the present invention generally include discrete surface features. For example, substrates typically include 6, 12, 24, 48, 96, 192, 384, 1536, or more surface features disposed on a surface. In preferred embodiments, the number of surface features of at least one of the substrates corresponds to at least a subset of the number of wells in a micro-well plate. The centers of adjacent surface features of at least one of the substrates are typically spaced 18 mm, 9 mm, 4.5 mm, 2.25 mm, or less apart from one another, such that they correspond to wells in various standard micro-well plates. In addition, adjacent surface features are typically sufficiently spaced apart from one another on substrate surfaces so that they can be fluidly separated from one another by separating members in an assembled apparatus. In some embodiments, for example, a surface of a standard microscope slide includes 48 microarrays that are arrayed in four columns that each includes 12 microarrays. In these embodiments, centers of adjacent microarrays are optionally spaced 4.5 mm apart from one another such that the spacing and dimensions of the array of microarrays correspond to those of a standard 384-well micro-well plate. As shown in the embodiment of the apparatus that is schematically depicted in the accompanying figures, apparatus 100 is structured to fluidly separate 48 surface features (e.g., each including a microarray or the like) on each of four substrates 108 or a total of 192 surface features. Substrate surface features typically include cross-sectional dimensions of 10000 μm or less, more typically 5000 μm or less, and still more typically of 200 μm or less.

The microarrays of the substrates of the invention include various embodiments. For example, arrays of oligonucleotides can be synthesized (i.e., producing probes in situ) using photolithographic methods as described in, e.g., U.S. Pat. No. 5,143,854, entitled “LARGE SCALE PHOTOLITHOGRAPHIC SOLID PHASE SYNTHESIS OF POLYPEPTIDES AND RECEPTOR BINDING SCREENING THEREOF” that issued Sep. 1, 1992 to Pirrung et al., and U.S. Pat. Application Publication No. U.S. 2002/0102564, entitled “PHOTOLITHOGRAPHIC METHOD AND SYSTEM FOR EFFICIENT MASK USAGE IN MANUFACTURING DNA ARRAYS,” published Aug. 1, 2002 by Mittmann et al., which are all incorporated by reference in their entirety for all purposes. Various microarrays produced using these methods are commercially available from suppliers, such as Affymetrix, Inc. (Santa Clara, Calif., USA).

In other embodiments, substrates are optionally employed on which microarrays have been synthesized using any of a variety of known techniques, many of which do not include photolithographic processes. For example, microarrays made by depositing, positioning, or spotting pre-synthesized or pre-selected probes on a substrate are also commercially available, e.g., on microscope slides. Additional details relating to spotted arrays are described in, e.g., U.S. Pat. No. 6,121,048, entitled “METHOD OF CONDUCTING A PLURALITY OF REACTIONS,” which issued Sep. 19, 2000 to Zaffaroni et al., U.S. Pat. No. 6,040,193, entitled “COMBINATORIAL STRATEGIES FOR POLYMER SYNTHESIS,” which issued Mar. 21, 2000 to Winkler et al., U.S. Pat. No. 5,885,837, entitled “VERY LARGE SCALE IMMOBILIZED POLYMER SYNTHESIS USING MECHANICALLY DIRECTED FLOW PATHS,” which issued Mar. 23, 1999 to Winkler et al., and U.S. Pat. No. 6,136,269, entitled “COMBINATORIAL KIT FOR POLYMER SYNTHESIS,” which issued Oct. 24, 2000 to Winkler et al., and in International Publication No. WO 99/36760, entitled “DEPOSITING FLUID SPECIMENS ON SUBSTRATES, RESULTING ORDERED ARRAYS, TECHNIQUES FOR ANALYSIS OF DEPOSITED ARRAYS,” published Jul. 22, 1999 by Flowers et al., which are all incorporated by reference in their entirety for all purposes. Other techniques for producing spotted arrays are based on, e.g., ejecting jets of biological material. Some embodiments of the jetting technique use devices such as syringes or piezo electric pumps to propel the biological material.

It should be noted that the apparatus and methods described herein may be applied with respect to many other types of probe arrays and, more generally, with respect to numerous parallel biological assays produced in accordance with other conventional technologies and/or produced in accordance with techniques that may be developed in the future. For example, arrayed probe molecules or sample materials are optionally disposed on slides, or on beads, optical fibers, or other substrates, supports, or media. Furthermore, in some embodiments, the probes need not be immobilized in or on a substrate, and, if immobilized, need not be disposed in regular patterns or arrays.

III. Apparatus Component Manufacture

Apparatus components (e.g., supporting members, separating members, sealing members, sealing components, etc.) or components thereof are optionally formed by various fabrication techniques or combinations of such techniques including, e.g., machining, stamping, engraving, injection molding, cast molding, embossing, extrusion, etching (e.g., electrochemical etching, etc.), or other techniques. These and other suitable fabrication techniques are generally known in the art and described in, e.g., Altintas, Manufacturing Automation: Metal Cutting Mechanics, Machine Tool Vibrations, and CNC Design, Cambridge University Press (2000), Molinari et al. (Eds.), Metal Cutting and High Speed Machining, Kluwer Academic Publishers (2002), Stephenson et al., Metal Cutting Theory and Practice, Marcel Dekker (1997), Rosato, Injection Molding Handbook, 3^{rd} Ed., Kluwer Academic Publishers (2000), Fundamentals of Injection Molding, W. J. T. Associates (2000), Whelan, Injection Molding of Thermoplastics Materials, Vol. 2, Chapman & Hall (1991), Fisher, Extrusion of Plastics, Halsted Press (1976), and Chung, Extrusion of Polymers: Theory and Practice, Hanser-Gardner Publications (2000), which are all incorporated by reference in their entirety for all purposes. In certain embodiments, following fabrication, supporting members, separating members, sealing members, or components thereof, are optionally further processed, e.g., by coating surfaces with a hydrophilic coating, a hydrophobic coating (e.g., a Xylan 1010DF/870 Black coating available from Whitford Corporation (West Chester, Pa., USA), etc.), or the like, e.g., to prevent interactions between component surfaces and reagents, samples, or the like.

The apparatus for fluidly separating substrate surface features are typically assembled from individually fabricated component parts (e.g., supporting members, separating members, sealing members, etc). Optionally, the apparatus of the invention are fabricated as single integral units that include substrates disposed therein. Apparatus fabrication materials are generally selected according to properties, such as reaction inertness, durability, expense, or the like. In preferred embodiments, apparatus, or components thereof, are fabricated from various metallic materials, such as stainless steel, anodized aluminum, or the like. Optionally, apparatus components are fabricated from polymeric materials such as, polytetrafluoroethylene (TEFLON™), polypropylene, polystyrene, polysulfone, polyethylene, polymethylpentene, polydimethylsiloxane (PDMS), polycarbonate, polyvinylchloride (PVC), polymethylmethacrylate (PMMA), or the like. Polymeric parts are typically economical to fabricate, which affords disposability. Apparatus or component parts are also optionally fabricated from other materials including, e.g., glass, silicon, or the like. Additional materials that are suitable for fabricating sealing components (e.g., gaskets, gasketing sheets, etc.) are described above. Sealing components are sometimes disposable or consumable components of the apparatus of the invention, whereas supporting members, separating members, and sealing members are typically intended to be used indefinitely.

IV. Systems for Processing Substrate Surface Features

The present invention also provides systems for processing substrate surface features (e.g., automated workstations or the like) that include the apparatus described herein, e.g., which are used to perform various microarray-based assays or the like. In particular, the systems of the invention include at least one apparatus having at least one separating member that includes at least one array of apertures disposed through the separating member, which array of apertures comprises a footprint that substantially corresponds to a footprint of at least a portion of an array of wells disposed in a micro-well plate. The apparatus also includes at least one supporting member structured to support and align at least one substrate so that when the substrate is supported by the supporting member and the supporting member is mated with the separating member, at least one aperture aligns with at least one surface feature of the substrate to fluidly separate the surface feature from at least one other surface feature of the substrate. As described above, substrate surface features typically include, e.g., microarrayed probe molecules, reagents, cells, cell lysates, or the like. The system also includes at least one fluid handling component (e.g., an automated multi-fluid pipetter or the like) that dispenses fluids to and/or aspirates fluids from fluidly separated surface features disposed on the substrate, when the substrate is supported by the supporting member and the supporting member is mated with the separating member. In preferred embodiments, the system further includes at least one controller (e.g., a computer or other information appliance) operably connected at least to the fluid handling component to control movement of fluids between the fluid handling component and the fluidly separated surface features.

In some embodiments, the system further includes at least one incubation component that incubates or regulates temperatures within the apparatus. Additional details regarding incubation devices that are optionally adapted for use with the system of the present invention are described in, e.g., International Publication No. WO 03/008103, entitled “HIGH THROUGHPUT INCUBATION DEVICES,” filed Jul. 18, 2002 by Weselak et al., which is incorporated by reference in its entirety for all purposes. The system also optionally further includes at least one detection component that detects detectable signals produced on the substrates. Detection components that are optionally included in the system of the invention are described further below and in, e.g., Skoog et al., Principles of Instrumental Analysis, 5^{th} Ed., Harcourt Brace College Publishers (1998), which is incorporated by reference in its entirety for all purposes. In certain embodiments, the system further includes at least one translocation component (e.g., at least one gripper apparatus or the like) that translocates the apparatus between the fluid handling component, the incubation component, and/or the detection component. Robotic gripping devices that are optionally adapted for use in the system of the invention are described further in, e.g., U.S. Pat. No. 6,592,324, entitled “GRIPPER MECHANISM,” issued Jul. 15, 2003 to Downs et al., and International Publication No. WO 02/068157, entitled “GRIPPING MECHANISMS, APPARATUS, AND METHODS,” by Downs et al., which are both incorporated by reference in their entirety for all purposes. In addition to the apparatus described herein, a system of the invention typically includes other vessels (e.g., flasks, test tubes, micro-well plates, or the like) that contain various fluidic materials (e.g., target molecule solutions, samples materials, etc.). Additional details relating to the systems of the invention are also provided below and in the documents that are incorporated by reference herein. Furthermore, an example system is also described below.

A. Controllers

The systems of the invention typically incorporate one or more controllers, either as separate or integral components (e.g., of fluid handling components), which are generally utilized, e.g., to regulate the quantities of samples or reagents dispensed and/or aspirated from wells disposed within the apparatus of the invention. A variety of available robotic elements (robotic arms, movable platforms, etc.) can be used or modified for use with, e.g., fluid handling components of these systems, which robotic elements are typically operably connected to controllers that control their movement and other functions.

To illustrate, controllers typically direct dipping of pipetting tips of fluid handling components of the systems into, e.g., selected wells of apparatus of the invention, wells in micro-well plates, or other reaction vessels, to dispense or extract, e.g., selected reagents, samples, or other fluidic materials. Typically, the controller systems of the present invention are appropriately configured to receive or interface with an apparatus or other system component as described herein. For example, the controller optionally includes a stage upon which the apparatus of the invention are disposed or mounted to facilitate appropriate interfacing among, e.g., fluid handlers and/or detectors and a particular apparatus for fluidly separating substrate surface features. Typically, the stage includes an appropriate mounting/alignment structural element, such as alignment pins and/or holes, a nesting well, or the like, e.g., to facilitate proper alignment with the apparatus of the invention. Corresponding alignment components of the apparatus of the invention are described above.

B. Detectors

The systems of the present invention optionally include various signal detectors, e.g., which detect light scattering, fluorescence, phosphorescence, radioactivity, mass, concentration, pH, charge, absorbance, refractive index, luminescence, temperature, magnetism, or the like. Detectors optionally monitor one or a plurality of signals from upstream and/or downstream of the performance of, e.g., a given assay step. For example, the detector optionally monitors a plurality of optical signals, which correspond in position to “real time” results. Example detectors or sensors include photomultiplier tubes, CCD arrays, optical sensors, temperature sensors, pressure sensors, pH sensors, conductivity sensors, scanning detectors, or the like. The detector optionally moves relative to assay components, or alternatively, assay components, such as samples of selected assay products move relative to the detector. Optionally, the systems of the present invention include multiple detectors. Each of these types of sensors is optionally readily incorporated into the systems described herein. In these systems, such detectors are typically placed either in or adjacent to, e.g., a particular apparatus or other vessel, such that the detector is within sensory communication with the vessel. The phrase “within sensory communication” of a particular region or element, as used herein, generally refers to the placement of the detector in a position such that the detector is capable of detecting the property of the vessel or portion thereof, the contents of a portion of the vessel, or the like, for which that detector was intended. The detector optionally includes or is operably linked to a computer, e.g., which has system software for converting detector signal information into assay result information or the like.

The detector optionally exists as a separate unit, or is integrated with the handling or controller system, into a single instrument. Integration of these functions into a single unit facilitates connection of these instruments with the computer (described below), by permitting the use of few or a single communication port(s) for transmitting information between system components.

Specific detection systems that are optionally used in the present invention include, e.g., a surface plasmon resonance spectrometer and imager, an ellipsometer, a resonance light scattering (RLS) detector, an emission spectroscope, a fluorescence spectroscope, a phosphorescence spectroscope, a luminescence spectroscope, a spectrophotometer, a photometer, a calorimeter, a mass spectrometer, a nuclear magnetic resonance spectrometer, an electron paramagnetic resonance spectrometer, an electron spin resonance spectroscope, a turbidimeter, a nephelometer, a Raman spectroscope, a refractometer, an interferometer, an x-ray diffraction analyzer, an electron diffraction analyzer, a polarimeter, an optical rotary dispersion analyzer, a circular dichroism spectrometer, a potentiometer, a chronopotentiometer, a coulometer, an amperometer, a conductometer, a gravimeter, a thermal gravimeter, a titrimeter, a differential scanning colorimeter, a radioactive activation analyzer, a radioactive isotopic dilution analyzer, or the like.

C. Computer

As noted above, the systems of the present invention optionally include a computer (or other information appliance) operably connected to or included within various system components. The computer typically includes system software that directs the handling and detection systems to, e.g., dispense fluids into selected wells or other vessels, to detect fluorescent emissions from target molecules, or the like. Additionally, the handling/controller system and/or the detection system is/are optionally coupled to an appropriately programmed processor or computer which functions to instruct the operation of these instruments in accordance with preprogrammed or user input instructions, receive data and information from these instruments, and interpret, manipulate and report this information to the user. As such, the computer is typically appropriately coupled to one or both of these instruments (e.g., including an analog to digital or digital to analog converter as needed).

Standard desktop applications such as word processing software (e.g., Microsoft Word™ or Corel WordPerfect™) and database software (e.g., spreadsheet software such as Microsoft Excel™, Corel Quattro Pro™, or database programs such as Microsoft Access™ or Paradox™) can be adapted to the present invention by inputting character strings corresponding to reagents or masses thereof. For example, the systems optionally include the foregoing software having the appropriate reagent information, e.g., used in conjunction with a user interface (e.g., a GUI in a standard operating system such as a Windows, Macintosh or LINUX system) to manipulate reagent information.

The computer can be, e.g., a PC (Intel x86 or Pentium chip-compatible DOS™, OS2™, WINDOWS™, WNDOWS NT™, WINDOWS95™, WINDOWS98™, WINDOWS2000™, WINDOWS XP™, LINUX-based machine, a MACINTOSH™, Power PC, or a UNIX-based (e.g., SUN™ work station) machine) or other common commercially available computer which is known to one of skill. Software for performing, e.g., microarray image scanning is optionally constructed by one of skill using a standard programming language such as Visual basic, Fortran, Basic, Java, or the like. Any controller or computer optionally includes a monitor which is often a cathode ray tube (“CRT”) display, a flat panel display (e.g., active matrix liquid crystal display, liquid crystal display, etc.), or others. Computer circuitry is often placed in a box, which includes numerous integrated circuit chips, such as a microprocessor, memory, interface circuits, and others. The box also optionally includes a hard disk drive, a floppy disk drive, a high capacity removable drive such as a writeable CD-ROM, and other common peripheral elements. Inputting devices such as a keyboard or mouse optionally provide for input from a user.

The computer typically includes appropriate software for receiving user instructions, either in the form of user input into a set of parameter fields, e.g., in a GUI, or in the form of preprogrammed instructions, e.g., preprogrammed for a variety of different specific operations. The software then converts these instructions to appropriate language for instructing the operation of one or more controllers to carry out the desired operation, e.g., varying or selecting the rate or mode of movement of various system components, directing X-Y-Z translation of the robotic gripping apparatus or fluid handling components, or of one or more micro-well plates or other vessels, or the like. The computer then receives the data from the one or more sensors/detectors included within the system, and interprets the data, either provides it in a user understood format, or uses that data to initiate further controller instructions, in accordance with the programming, e.g., such as in monitoring reaction temperatures, emission signal intensity, or the like.

V. Methods for Performing Array-Based Assays

The present invention also provides methods of performing array-based assays. The methods include providing an apparatus that typically includes a footprint that substantially corresponds to a footprint of a micro-well plate. The apparatus also includes at least one array of one or more probe components disposed on a surface of at least one substrate in which the substrate is disposed and aligned in a supporting member that is removably mated with a separating member. Optionally, the substrate includes a plurality of substrates and/or the array includes a plurality of arrays. The separating member fluidly separates at least one member of the array from at least one other member of the array on the substrate. In preferred embodiments, a plurality of arrays are disposed on surfaces of two or more substrates in which the substrates are disposed in an apparatus of the invention. In these embodiments, separating members of the apparatus typically fluidly separate at least two members of one or more arrays disposed on at least one substrate from one another. The methods further include contacting selected members of the array with one or more target components and incubating the apparatus for a time that is sufficient to allow interaction (e.g., target and probe component binding or the like), if any, between the target components and probe components disposed on the selected members. Optionally, the apparatus is sealed with a sealing member prior to the incubating step.

Arrays optionally include essentially any number of members. In some embodiments, for example, the array includes 12, 24, 48, 96, 192, 384, 1536, or more members, e.g., to correspond to the number of wells in a standard micro-well plate. In preferred embodiments, one or more members of the array include microarrays of the probe components. To illustrate, the target and probe components are optionally independently selected from, e.g., cells, cell lysates, organic molecules, inorganic molecules, oligonucleotides, polynucleotides, DNA, RNA, peptide nucleic acids, peptides, polypeptides, proteins, antibodies, sugars, saccharides, polysaccharides, carbohydrates, etc. In some embodiments, for example, the target and probe components include nucleic acid molecules and the array-based assays include hybridization assays. Arrayed probes are also discussed further above.

The methods optionally further include removing non-interacting target components from contact with the selected members. For example, the removing step optionally includes washing the non-interacting target components from contact with the selected members. In certain embodiments, the methods further include removing the substrate from the apparatus, and performing one or more parallel processes on the array disposed on the substrate. To illustrate, the parallel processes are optionally include, e.g., blocking the array, washing the array, staining the array, preserving the array, imaging the array, or the like. The target components generally include one or more labels and the method typically further includes detecting one or more detectable signals produced by interacting target and probe components.

Additional details regarding array-based assays (e.g., microarray-based assays) that are optionally adapted for use with the apparatus, systems, and methods of the present invention are provided in various sources. Some of these include, e.g., U.S. Pat. No. 5,143,854, entitled “LARGE SCALE PHOTOLITHOGRAPHIC SOLID PHASE SYNTHESIS OF POLYPEPTIDES AND RECEPTOR BINDING SCREENING THEREOF,” which issued Sep. 1, 1992 to Pirrung et al.; U.S. Pat. No. 5,384,261, entitled “VERY LARGE SCALE IMMOBILIZED POLYMER SYNTHESIS USING MECHANICALLY DIRECTED FLOW PATHS,” which issued Jan. 24, 1995 to Winkler et al.; U.S. Pat. No. 5,405,783, entitled “LARGE SCALE PHOTOLITHOGRAPHIC SOLID PHASE SYNTHESIS OF AN ARRAY OF POLYMERS,” which issued Apr. 11, 1995 to Pirrung et al.; U.S. Pat. No. 5,412,087, entitled “SPATIALLY-ADDRESSABLE IMMOBILIZATION OF OLIGONUCLEOTIDES AND OTHER BIOLOGICAL POLYMERS ON SURFACES,” which issued May 2, 1995 to McGall et al.; U.S. Pat. No. 5,424,186, entitled “VERY LARGE SCALE IMMOBILIZED POLYMER SYNTHESIS,” which issued Jun. 13, 1995 to Fodor et al.; U.S. Pat. No. 5,445,934, entitled “ARRAY OF OLIGONUCLEOTIDES ON A SOLID SUBSTRATE,” which issued Aug. 29, 1995 to Fodor et al.; U.S. Pat. No. 5,545,531, entitled “METHODS FOR MAKING A DEVICE FOR CONCURRENTLY PROCESSING MULTIPLE BIOLOGICAL CHIP ASSAYS,” which issued Aug. 13, 1996 to Rava et al.; U.S. Pat. No. 5,744,305, entitled “ARRAYS OF MATERIALS ATTACHED TO A SUBSTRATE,” which issued Apr. 28, 1998 to Fodor et al.; U.S. Pat. No. 5,800,992, entitled “Method of detecting nucleic acids,” which issued Sep. 1, 1998 to Fodor et al.; U.S. Pat. No. 6,027,880, entitled “ARRAYS OF NUCLEIC ACID PROBES AND METHODS OF USING THE SAME FOR DETECTING CYSTIC FIBROSIS,” which issued Feb. 22, 2000 to Cronin et al.; U.S. Pat. No. 5,874,219, entitled “METHODS FOR CONCURRENTLY PROCESSING MULTIPLE BIOLOGICAL CHIP ASSAYS,” which issued Feb. 23, 1999 to Rava et al.; U.S. Pat. No. 6,040,138, entitled “EXPRESSION MONITORING BY HYBRIDIZATION TO HIGH DENSITY OLIGONUCLEOTIDE ARRAYS,” which issued Mar. 21, 2000 to Lockhart et al.; U.S. Pat. No. 6,040,193, entitled “COMBINATORIAL STRATEGIES FOR POLYMER SYNTHESIS,” which issued Mar. 21, 2000 to Winkler et al.; U.S. Pat. No. 6,140,044, entitled “METHOD AND APPARATUS FOR PACKAGING A PROBE ARRAY,” which issued Oct. 31, 2000 to Besemer et al.; U.S. Pat. No. 6,150,147, entitled “Biological array fabrication methods with reduction of static charge,” which issued Nov. 21, 2000 to Goldberg et al.; U.S. Pat. No. 6,153,743, entitled “LITHOGRAPHIC MASK DESIGN AND SYNTHESIS OF DIVERSE PROBES ON A SUBSTRATE,” which issued Nov. 28, 2000 to Hubbell et al.; U.S. Pat. No. 6,185,561, entitled “METHOD AND APPARATUS FOR PROVIDING AND EXPRESSION DATA MINING DATABASE,” which issued Feb. 6, 2001 to Balaban et al.; and U.S. Pat. No. 6,291,183, entitled “VERY LARGE SCALE IMMOBILIZED POLYMER SYNTHESIS,” which issued Sep. 18, 2001 to Pirrung et al., each of which are incorporated by reference in their entirety for all purposes. Other aspects of microarray-based assays that are adapted for use with the present invention are provided in various international publications, such as International Publication No. WO 92/10092, entitled “VERY LARGE SCALE IMMOBILIZED POLYMER SYNTHESIS,” which published Jun. 25, 1992 by Fodor et al., which is incorporated by reference in its entirety for all purposes.

VI. Kits

The present invention also provides kits that include at least one apparatus described herein, or components of such an apparatus. For example, a kit typically includes at least one separating member (e.g., a grid plate, etc.), at least one supporting member, and at least one sealing component (e.g., a gasket, etc.) that is positioned between mated separating and supporting members as described herein. When the supporting and separating members removably mate with one another, the kits also typically include fasteners (e.g., screws, clamps, latches, etc.) to fasten these components to one another. In certain embodiments, kits further include at least one sealing member (e.g., a lid, a cover, or the like) and at least one additional sealing member that is placed, e.g., between mated lids and grid plates. The apparatus of the kits of the invention are optionally pre-assembled (e.g., include separating and supporting members that are integral with one another, etc.) or unassembled.

Kits are optionally packaged to further include substrates, reagents, and control/calibrating materials for performing selected arrayed-based assays in the apparatus of the invention. For example, kits optionally include substrates either with or without arrayed materials (e.g., DNA microarrays, etc.) disposed on surface features of the substrates. In the case of pre-packaged reagents, the kits optionally include pre-measured or pre-dosed reagents that are ready to incorporate into a particular protocol without measurement, e.g., pre-measured fluid aliquots, or pre-weighed or pre-measured solid reagents that can be easily reconstituted by the end-user of the kit. Generally, reagents are provided in a stabilized form, so as to prevent degradation or other loss during prolonged storage, e.g., from leakage. A number of stabilizing processes are widely used for reagents that are to be stored, such as the inclusion of chemical stabilizers (i.e., enzymatic inhibitors, microcides/bacteriostats, anticoagulants), the physical stabilization of the material, e.g., through immobilization on a solid support, entrapment in a matrix (i.e., a gel), lyophilization, or the like. In certain embodiments, kits include only selected apparatus components, such as disposable gaskets, or other components (e.g., lids, grid plates, supporting members, etc.). Kits typically include appropriate instructions for assembling, utilizing, and maintaining the apparatus or components thereof. Kits also typically include packaging materials or containers for holding kit components.

VII. Example System for Processing Substrate Surface Features

FIG. 10 is a schematic showing a representative example assay system including a logic device in which various aspects of the present invention may be embodied. As will be understood by practitioners in the art from the teachings provided herein, the invention is optionally implemented in hardware and software. In some embodiments, different aspects of the invention are implemented in either client-side logic or server-side logic. As will be understood in the art, the invention or components thereof may be embodied in a media program component (e.g., a fixed media component) containing logic instructions and/or data that, when loaded into an appropriately configured computing device, cause that apparatus or system to perform according to the invention. As will also be understood in the art, a fixed media containing logic instructions may be delivered to a viewer on a fixed media for physically loading into a viewer's computer or a fixed media containing logic instructions may reside on a remote server that a viewer accesses through a communication medium in order to download a program component.

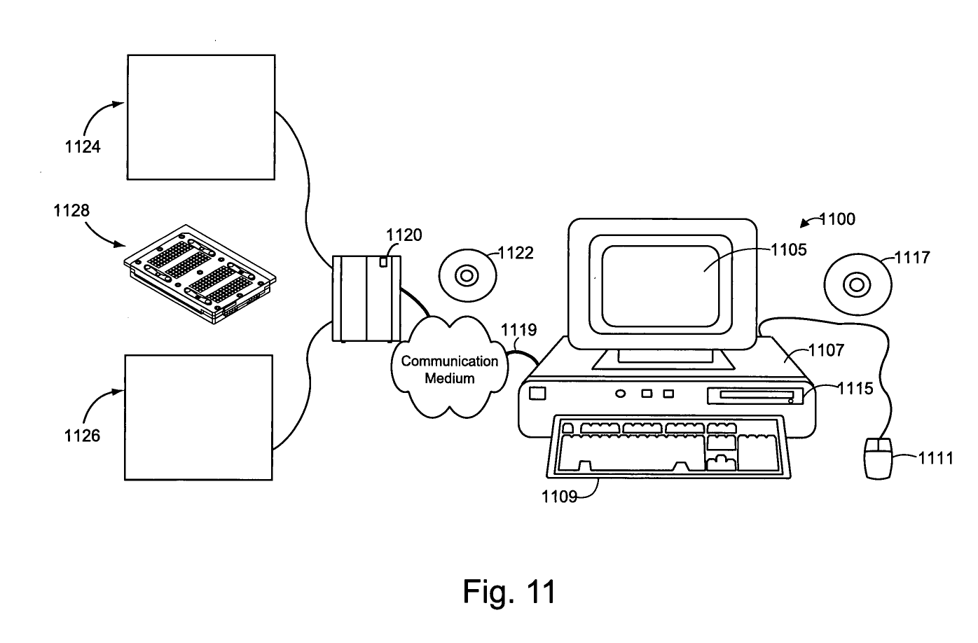

FIG. 11 shows information appliance or digital device 1100 that may be understood as a logical apparatus (e.g., a computer, etc.) that can read instructions from media 1117 and/or network port 1119, which can optionally be connected to server 1120 having fixed media 1122. Digital device 1100 can thereafter use those instructions to direct server or client logic, as understood in the art, to embody aspects of the invention. One type of logical apparatus that may embody the invention is a computer system as illustrated in 1100, containing CPU 1107, optional input devices 1109 and 1111, disk drives 1115 and optional monitor 1105. Fixed media 1117, or fixed media 1122 over port 1119, may be used to program such a system and may represent a disk-type optical or magnetic media, magnetic tape, solid state dynamic or static memory, or the like. In specific embodiments, the aspects of the invention may be embodied in whole or in part as software recorded on this fixed media. Communication port 1119 may also be used to initially receive instructions that are used to program such a system and may represent any type of communication connection. Optionally, aspects of the invention is embodied in whole or in part within the circuitry of an application specific integrated circuit (ACIS) or a programmable logic device (PLD). In such a case, aspects of the invention may be embodied in a computer understandable descriptor language, which may be used to create an ASIC, or PLD.

FIG. 11 also includes fluid handling system 1124 and detection system 1126, both of which are operably connected to digital device 1100 via server 1120. Optionally, handling system 1124 and/or detection system 1126 are directly connected to digital device 1100. During operation, fluid handling system 1124 typically distributes fluidic materials (e.g., target component solutions, etc.) to selected wells of apparatus 1128. Fluid handling system 1124 also optionally aspirates fluids from selected wells of apparatus 1128, e.g., following a hybridization step or the like. Detection system 1126 optionally includes a microarray scanner for detecting fluorescent emissions, e.g., from microarrayed DNA probe molecules following hybridization with target molecules. Digital device 1100 digitizes, stores, and manipulates signal information detected by detection system 1126 using one or more logic instructions.

While the foregoing invention has been described in some detail for purposes of clarity and understanding, it will be clear to one skilled in the art from a reading of this disclosure that various changes in form and detail can be made without departing from the true scope of the invention. For example, all the techniques and apparatus described above may be used in various combinations. All publications, patents, patent applications, or other documents cited in this application are incorporated by reference in their entirety for all purposes to the same extent as if each individual publication, patent, patent application, or other document were individually indicated to be incorporated by reference for all purposes.

What is claimed is:

1. An apparatus for fluidly separating substrate surface features, comprising:
at least one separating member that comprises at least one array of apertures disposed through the separating member, which array of apertures comprises a footprint that substantially corresponds to a footprint of at least a portion of an array of wells disposed in a micro-well plate; and,
at least one supporting member structured to support and align at least one substrate so that when the substrate is supported by the supporting member and the supporting member is mated with the separating member, at least one aperture aligns with at least one surface feature of the substrate to fluidly separate the surface feature from at least one other surface feature of the substrate.

2. The apparatus of claim 1, wherein the separating member comprises a grid plate.

3. The apparatus of claim 1, wherein the number of arrays of apertures disposed through the separating member corresponds to the number of substrates that the supporting member is structured to support.

4. The apparatus of claim 1, wherein centers of adjacent apertures in the array of apertures are spaced 18 mm, 9 mm, 4.5 mm, 2.25 mm, or less apart from one another.

5. The apparatus of claim 1, wherein the number of spacing regions disposed between adjacent apertures in a line of apertures in the array of apertures is a multiple of the number of spacing regions disposed between adjacent wells in a corresponding line of wells disposed in a micro-well plate.

6. The apparatus of claim 1, wherein at least one aperture in the array of apertures comprises a cross-sectional shape selected from the group consisting of: a regular n-sided polygon, an irregular n-sided polygon, a triangle, a square, a rectangle, a trapezoid, a circle, and an oval.

7. The apparatus of claim 1, wherein at least one aperture in the array of apertures comprises a cross-sectional area of at least 1 mm².

8. The apparatus of claim 1, wherein the array of apertures comprises 6, 24, 48, 96, 192, 384, 1536, or more apertures.

9. The apparatus of claim 1, wherein the supporting member comprises at least two datum surfaces that are structured to align the substrate relative to the array of apertures when the supporting member supports the substrate and the supporting member is mated with the separating member.

10. The apparatus of claim 1, wherein the supporting member is structured to support one or more substrates that are removable from the supporting member when the separating member is not mated with the supporting member.

11. The apparatus of claim 1, wherein the supporting member is structured to support 1, 2, 3, 4, 5, 6, 7, 8, or more substrates.

12. The apparatus of claim 1, wherein the supporting member comprises one or more orifices through which detectable signals that are produced on substrates disposed in the apparatus are detected.

13. The apparatus of claim 1, wherein the supporting and separating members removably mate with one another.

14. The apparatus of claim 1, wherein a footprint of the apparatus substantially corresponds to a footprint of a micro-well plate.

15. The apparatus of claim 1, wherein at least one surface of the supporting member and/or the separating member further comprises a hydrophobic coating.

16. The apparatus of claim 1, further comprising at least one liner that comprises one or more inserts that insert into one or more apertures of the separating member.

17. The apparatus of claim 1, wherein the separating member further comprises one or more positioning components that position one or more substrates relative to the separating member when the substrates are supported by the supporting member and the supporting member is mated with the separating member.

18. The apparatus of claim 17, wherein the positioning components are resiliently coupled to the separating member by at least one resilient coupling component.

19. The apparatus of claim 1, wherein the supporting member comprises one or more alignment components that correspond to one or more alignment components on the separating member to align mated supporting and separating members.

20. The apparatus of claim 19, wherein the alignment components comprise corresponding pairs of pins and holes.

21. The apparatus of claim 1, wherein a surface of the supporting member that engages the separating member when the supporting member is mated with the separating member comprises one or more recessed regions that are structured to receive and support one or more substrates.

22. The apparatus of claim 21, wherein the supporting member comprises a supporting plate.

23. The apparatus of claim 21, wherein the supporting member comprises 1, 2, 3, 4, 5, 6, 7, 8, or more recessed regions.

24. The apparatus of claim 21, wherein the supporting member comprises one or more access features that allow access to substrates disposed in the recessed regions when the separating member is not mated with the supporting member.

25. The apparatus of claim 1, further comprising one or more substrates.

26. The apparatus of claim 25, wherein the supporting and separating members are integral with one another.

27. The apparatus of claim 25, wherein at least one of the substrates comprises a surface having a surface area of at least 1875 mm².

28. The apparatus of claim 25, wherein surface features of at least one of the substrates comprise discrete surface features.

29. The apparatus of claim 25, wherein at least one of the substrates comprises a membrane.

30. The apparatus of claim 25, wherein centers of adjacent surface features of at least one of the substrates are spaced 18 mm, 9 mm, 4.5 mm, 2.25 mm, or less apart from one another.

31. The apparatus of claim 25, wherein one or more surface features of at least one of the substrates comprise a cross-sectional dimension of 200 μm or less.

32. The apparatus of claim 25, wherein the number of surface features of at least one of the substrates corresponds to at least a subset of the number of wells in a micro-well plate.

33. The apparatus of claim 25, wherein at least one of the substrates comprises 6, 12, 24, 48, 96, 192, 384, 1536, or more surface features disposed on a surface.

34. The apparatus of claim 25, wherein one or more surface features of at least one of the substrates comprise microarrays.

35. The apparatus of claim 34, wherein the microarrays comprise arrayed probe molecules.

36. The apparatus of claim 35, wherein the probe molecules are selected from the group consisting of: organic molecules, inorganic molecules, oligonucleotides, polynucleotides, DNA, RNA, peptide nucleic acids, peptides, polypeptides, proteins, antibodies, sugars, saccharides, polysaccaharides, and carbohydrates.

37. The apparatus of claim 25, wherein one or more surface features of at least one of the substrates comprise samples.

38. The apparatus of claim 37, wherein the samples comprises chemical reagents, cells, or cell lysates.

39. The apparatus of claim 25, wherein at least one of the substrates comprises a glass or polymeric substrate.

40. The apparatus of claim 39, wherein the glass or polymeric substrate is a microscope slide.

41. The apparatus of claim 25, wherein the array of apertures and at least one of the substrates together form an array of wells when the separating member is mated with the supporting member.

42. The apparatus of claim 41, wherein at least one well comprises a volume capacity of between 1 μl and 100 μl.

43. The apparatus of claim 1, further comprising at least one sealing component disposed between the separating member and the substrates to further fluidly separate surface features when one or more substrates are supported by the supporting member and the supporting member is mated with the separating member.

44. The apparatus of claim 43, wherein the sealing component comprises at least one gasket.

45. The apparatus of claim 43, wherein the sealing component is formed around each aperture in the array of apertures.

46. The apparatus of claim 43, wherein the sealing component is integral with the separating member.

47. The apparatus of claim 43, wherein at least portions of the sealing component comprise cross-sectional shapes that allow sealing to occur on multiple sides of the sealing component when the sealing component is subjected to a compressive load.

48. The apparatus of claim 43, wherein separate sealing components that correspond to each of the substrates are disposed between the separating member and the substrates when multiple substrates are supported by the supporting member and the supporting member is mated with the separating member.

49. The apparatus of claim 48, wherein 2, 3, 4, 5, 6, 7, 8, or more separate sealing components are disposed between the separating member and the substrates.

50. The apparatus of claim 43, wherein a surface of the separating member that engages the supporting member when the separating member is mated with the supporting member comprises one or more recessed grooves that are structured to receive a portion of the sealing component.

51. The apparatus of claim 50, wherein a depth of the recessed grooves in the separating member and a depth of recessed regions in the supporting member that are structured to support the substrates optimally compress the sealing component between the separating member and the substrates when the substrates are supported by the supporting member and the supporting member is mated with the separating member.

52. The apparatus of claim 1, further comprising at least one sealing member structured to seal at least one separated surface feature of one or more substrates when the sealing member is mated with the apparatus, and when the substrates are supported by the supporting member and the supporting member is mated with the separating member.

53. The apparatus of claim 52, wherein the sealing member comprises a lid.

54. The apparatus of claim 52, wherein a footprint of the sealing member substantially corresponds to a footprint of a micro-well plate.

55. The apparatus of claim 52, wherein the sealing member comprises one or more alignment features to align the sealing member with the apparatus and/or another device.

56. The apparatus of claim 52, further comprising at least one sealing component disposed between the sealing and separating members to further seal the separated surface feature of the substrates when the sealing member is mated with the apparatus.

57. The apparatus of claim 56, wherein the sealing component comprises a gasket.

58. The apparatus of claim 56, wherein the sealing component is formed around each aperture in the array of apertures disposed through the separating member.

59. The apparatus of claim 56, wherein a surface of the sealing member that engages the separating member when the sealing member is mated with the separating member comprises one or more recessed grooves that are structured to receive a portion of the sealing component.

60. The apparatus of claim 56, wherein the sealing component is integral with the sealing member.

61. The apparatus of claim 56, wherein at least portions of the sealing component comprise cross-sectional shapes that allow sealing to occur on multiple sides of the sealing component when the sealing component is subjected to a compressive load.

62. The apparatus of claim 56, wherein separate sealing components that correspond to each substrate are disposed between the separating and sealing members.

63. The apparatus of claim 62, wherein 2, 3, 4, 5, 6, 7, 8, or more separate sealing components are disposed between the separating and sealing members.

64. The apparatus of claim 1, further comprising one or more fasteners that fasten mated separating and supporting members together.

65. The apparatus of claim 64, wherein the fasteners comprise screws.

66. An apparatus for fluidly separating substrate surface features, comprising:
at least one supporting member structured to support and align two or more substrates; and,
at least one separating member structured to fluidly separate at least two surface features disposed on at least one substrate from one another when the substrates are supported by the supporting member and the supporting member is mated with the separating member.

67. The apparatus of claim 66, wherein the separating member comprises at least one array of apertures disposed through the separating member, which apertures each align with one or more surface features of the substrates to fluidly separate the at least two surface features disposed on each substrate from one another when the substrates are supported by the supporting member and the supporting member is mated with the separating member.

68. The apparatus of claim 66, wherein the supporting member comprises datum surfaces that are structured to align the substrates relative to the separating member when the supporting member supports the substrates and the supporting member is mated with the separating member.

69. The apparatus of claim 66, wherein the supporting member is structured to support 2, 3, 4, 5, 6, 7, 8, or more substrates.

70. The apparatus of claim 66, wherein the supporting and separating members removably mate with one another.

71. The apparatus of claim 66, wherein a footprint of the apparatus substantially corresponds to a footprint of a micro-well plate.

72. The apparatus of claim 66, further comprising at least one liner that comprises one or more inserts that insert into one or more apertures of the separating member.

73. The apparatus of claim 66, further comprising the two or more substrates.

74. The apparatus of claim 73, wherein one or more surface features of at least one of the substrates comprise microarrayed probe molecules, reagents, cells, or cell lysates.

75. The apparatus of claim 73, wherein at least one of the substrates is a microscope slide.

76. The apparatus of claim 66, further comprising at least one sealing component disposed between the separating member and the substrates to further fluidly separate surface features when the substrates are supported by the supporting member and the supporting member is mated with the separating member.

77. The apparatus of claim 76, wherein the sealing component comprises at least one gasket.

78. The apparatus of claim 66, further comprising at least one sealing member structured to seal at least one separated surface feature of the substrates when the sealing member is mated with the apparatus, and when the substrates are supported by the supporting member and the supporting member is mated with the separating member.

79. The apparatus of claim 78, wherein the sealing member comprises a lid.

80. An apparatus for fluidly separating substrate surface features, comprising:
at least one separating member that comprises at least one array of apertures disposed through the separating member, which array of apertures comprises a footprint that substantially corresponds to a footprint of at least a portion of an array of wells disposed in a micro-well plate; and,
at least one supporting member structured to support and align two or more substrates so that when the substrates are supported by the supporting member and the supporting member is mated with the separating member, apertures align with surface features of the substrates to fluidly separate at least two surface features disposed on at least one substrate from one another.

81. A system for processing substrate surface features, the system comprising:
at least one apparatus, comprising:
at least one separating member that comprises at least one array of apertures disposed through the separating member, which array of apertures comprises a footprint that substantially corresponds to a footprint of at least a portion of an array of wells disposed in a micro-well plate; and
at least one supporting member structured to support and align at least one substrate so that when the substrate is supported by the supporting member and the supporting member is mated with the separating member, at least one aperture aligns with at least one surface feature of the substrate to fluidly separate the surface feature from at least one other surface feature of the substrate; and,
at least one fluid handling component that dispenses fluids to and/or aspirates fluids from fluidly separated surface features disposed on the substrate, when the substrate is supported by the supporting member and the supporting member is mated with the separating member.

82. The system of claim 81, further comprising:
at least one controller operably connected at least to the fluid handling component to control movement of fluids between the fluid handling component and the fluidly separated surface features.

83. The system of claim 81, further comprising the substrate.

84. The system of claim 83, wherein the surface features comprise microarrayed probe molecules, reagents, cells, or cell lysates.

85. The system of claim 84, wherein the fluids comprise target molecules.

86. The system of claim 81, further comprising:
at least one incubation component that incubates the apparatus.

87. The system of claim 81 or 86, further comprising:
at least one detection component that detects detectable signals produced on the substrates.

88. The system of claim 87, further comprising:
at least one translocation component that translocates the apparatus between the fluid handling component, the incubation component, and/or the detection component.

89. The system of claim 88, wherein the translocation component comprises at least one gripper apparatus.

90. A method of performing array-based assays, the method comprising:
providing an apparatus having a footprint that substantially corresponds to a footprint of a micro-well plate and comprising at least one array of one or more probe components disposed on a surface of at least one substrate, wherein the substrate is disposed and aligned in a supporting member that is removably mated with a separating member, which separating member fluidly separates at least one member of the array from at least one other member of the array on the substrate;
contacting selected members of the array with one or more target components; and,
incubating the apparatus for a time that is sufficient to allow interaction, if any, between the target components and the probe components of the selected members, thereby performing the array-based assays.

91. The method of claim 90, wherein the substrate comprises a plurality of substrates.

92. The method of claim 90, wherein the array comprises a plurality of arrays.

93. The method of claim 90, wherein the array comprises 12, 24, 48, 96, 192, 384, 1536, or more members.

94. The method of claim 90, wherein the interaction comprises target and probe component binding.

95. The method of claim 90, wherein the target and probe components comprise nucleic acid molecules and the array-based assays comprise hybridization assays.

96. The method of claim 90, wherein the apparatus is sealed with a sealing member prior to the incubating step.

97. The method of claim 90, wherein one or more members of the array comprise microarrays of the probe components.

98. The method of claim 90 or 97, wherein the target and probe components are independently selected from the group consisting of: cells, cell lysates, organic molecules, inorganic molecules, oligonucleotides, polynucleotides, DNA, RNA, peptide nucleic acids, peptides, polypeptides, proteins, antibodies, sugars, saccharides, polysaccharides, and carbohydrates.

99. The method of claim 90, further comprising:
removing non-interacting target components from contact with the selected members.

100. The method of claim 99, wherein the removing step comprises washing the non-interacting target components from contact with the selected members.

101. The method of claim 99, further comprising:
removing the substrate from the apparatus; and,
performing one or more parallel processes on the array disposed on the substrate.

102. The method of claim 101, wherein the parallel processes are selected from the group consisting of: blocking the array, washing the array, staining the array, and preserving the array.

103. The method of claim 99 or 101, wherein the target components comprise one or more labels and the method further comprises:
detecting one or more detectable signals produced by interacting target and probe components.

104. A method of performing array-based assays, the method comprising:
providing an apparatus that comprises a plurality of arrays disposed on surfaces of two or more substrates, wherein the substrates are disposed and aligned in a supporting member that is removably mated with a separating member, which separating member fluidly separates at least two members of one or more arrays disposed on at least one substrate from one another;
contacting selected members of the plurality of arrays with one or more target components; and,
incubating the apparatus for a time that is sufficient to allow interaction, if any, between the target components and probe components of the selected members, thereby performing the array-based assays.

105. A kit to perform array-based assays, comprising:
at least one apparatus for fluidly separating substrate surface features that comprises:
at least one separating member that comprises at least one array of apertures disposed through the separating member, which array of apertures comprises a footprint that substantially corresponds to a footprint of at least a portion of an array of wells disposed in a micro-well plate; and
at least one supporting member structured to support and align at least one substrate so that when the substrate is supported by the supporting member and the supporting member is mated with the separating member, at least one aperture aligns with at least one surface feature of the substrate to fluidly separate the surface feature from at least one other surface feature of the substrate; and,
at least one set of instructions that directs use of the apparatus.

106. The kit of claim 105, further comprising one or more substrates.
